(19) United States
(12) Patent Application Publication
(10) Pub. No.: US 2023/0347616 A1
(43) Pub. Date: Nov. 2, 2023

(54) Systems and Methods for Making Improved Expandable Slit-Sheet-Material

(71) Applicant: David Paul Goodrich, Sedona, AZ (US)

(72) Inventor: David Paul Goodrich, Sedona, AZ (US)

(21) Appl. No.: 18/115,120

(22) Filed: Feb. 28, 2023

Related U.S. Application Data
(60) Provisional application No. 63/430,499, filed on Dec. 6, 2022.
(60) Provisional application No. 63/268,696, filed on Feb. 28, 2022.

(51) Int. Cl. B31D 5/00; B26D 7/20

(52) U.S. Cl. CPC B31D 5/0065; B26D 7/204

(57) ABSTRACT

According to some illustrative embodiments, a method of making slit sheet material product is provided that includes: providing a die having a first pressing member and second pressing member, wherein the first pressing member and the second pressing member are employed to press on opposite sides of a sheet of material, and wherein the first pressing member has a plurality of blades configured to penetrate and pass through the sheet of material to form an expandable slit sheet material, and wherein the plurality of blades further penetrate a surface of the second pressing member. In preferred embodiments, the second pressing member includes an intermediary material layer therearound and said plurality of blades penetrate said intermediary material layer. According to various embodiments, novel and advantageous expandable slit sheet material products are created by the novel methods described herein.

The present application is a non-provisional of both U.S. Provisional Application Ser. No. 63/268,696, filed Feb. 28, 2022 and Ser. No. 63/430,499, filed Dec. 6, 2022, the entire disclosures of which are incorporated herein by reference as if recited herein in full.

### BACKGROUND

Incorporation-by-References to Prior-Filed Applications of the Present Inventor

The present application incorporates by reference the subject matter of each of the following prior U.S. applications and patents of the present inventor, the entire disclosures of which are incorporated herein by reference as if recited herein in full and are attached as Appendices hereto as part of this application:
1. U.S. application Ser. No. 16/018,702, filed Jun. 26, 2020, now U.S. Pat. No. 10,669,086;
2. U.S. Pat. No. 10,226,907;
3. U.S. patent application Ser. No. 16/870,195 (U.S. Publication No. 2020-0270048), filed May 8, 2020, entitled “Extensible Paper and its Use in the Production of Expanded Slit Packaging Wrap and Void Fill Products;”
4. U.S. patent application Ser. No. 16/929,836 (U.S. Publication No. 2021-0031996), entitled Expanded Slit Sheet Cushioning Products with Novel Slit Pattern and Paper Properties);
5. U.S. patent application Ser. No. 16/929,843 (U.S. Publication No. 2021-0031997), entitled Expanded Slit Sheet Cushioning Products with Novel Slit Pattern and Paper Properties;
6. U.S. Pat. No. 10,981,712;
7. U.S. patent application Ser. No. 17/175,148 (U.S. Publication No. 2021-0245908);
8. U.S. Provisional Patent Application No. 63/190,025, entitled Systems and Methods for Wrapping Pallets and the Like with Expandable Paper.

### FIELD

This preferred embodiments of the present invention relate to the use of slit sheet material that is expanded to provide, e.g., a cushioning product, a fill product, a wrap product and/or other product employing expandable slit sheet material. In the preferred embodiments, the present invention provides substantially improved expandable slit sheet material products by greatly improving the formation of such expandable slit sheet materials.

The preferred embodiments of the present invention greatly improve upon and overcome various problems and limitations of the related art.

### SUMMARY

The preferred embodiments overcome and improve upon the foregoing and/or other related art.

1. According to a first illustrative embodiment of the invention, a method of making slit sheet material product is performed that includes:
providing a die having a first pressing member and second pressing member, wherein the first pressing member and the second pressing member are employed to press on opposite sides of a sheet of material, and wherein the first pressing member has a plurality of blades configured to penetrate and pass through the sheet of material to form an expandable slit sheet material, and wherein the plurality of blades further penetrate a surface of the second pressing member.

2. In some examples, the method according to 1 above further includes that said second pressing member includes an intermediary material layer therearound and said plurality of blades penetrate said intermediary material layer.

3. In some examples, the method according to 1 above further includes that said blades penetrate said intermediary material layer, but do not extend below said intermediary material layer.

4. According to another illustrative embodiment, a device for manufacture of an expandable slit sheet material is provided that includes:
a die having a first pressing member and second pressing member,
the first pressing member and the second pressing member being arranged to press on opposite sides of a sheet of material,
the first pressing member having a plurality of blades configured to penetrate and pass through the sheet of material to form an expandable slit sheet material, and
the plurality of blades further penetrating a surface of the second pressing member.

5. In some examples, the device according to 4 further includes that said second pressing member includes an intermediary material layer therearound and said plurality of blades penetrate said intermediary material layer.

6. In some examples, the device according to 4 further includes that said blades penetrate said intermediary material layer, but do not extend below said intermediary material layer.

7. According to some other illustrative embodiments, a method of upgrading a device for making expandable slit sheet material is performed that includes:
providing a device for making an expandable slit sheet material by cutting an array of slits in a sheet of material to form the expandable slit sheet material, wherein the device includes a first pressing member having a plurality of blades extending therefrom and a second pressing member, wherein the first pressing member and the second pressing member are arranged to sandwich the sheet of material;
upgrading the device for making an expandable slit sheet material by applying an intermediary material layer on a surface of the second pressing member, such that the blades of the first pressing member are configured to pass through the sheet of material to form an expandable slit sheet material, and such that the plurality of blades further penetrate a surface of the intermediate material layer.

8. In some examples, the method according to 7 further includes that said blades penetrate said intermediary material layer, but do not extend below said intermediary material layer.

9. According to some other illustrative embodiments, an expandable slit sheet paper product is provided that includes:
a sheet of fibrous material having an array of slits formed therein such that the sheet of material is expandable into an array of cells upon applying a tensile pulling force along the plane of the sheet of material in a direction perpendicular to the direction of the slits within the sheet of material;
wherein prior to expansion of said sheet of fibrous material, said sheet of fibrous material is substantially free of:
a) connecting fibers extending across said slits formed in the sheet of fibrous material; and/or
b) compressed regions adjacent to said slits caused by crush-cutting forces causing compression of the sheet of fibrous material.

10. In some examples, the expandable slit sheet paper product of 9 further includes that said sheet of fibrous material is substantially free of connecting fibers extending across said slits formed in the sheet of fibrous material.

11. In some examples, the expandable slit sheet paper product of 10 further includes that greater than 70% of said slits are free of connecting fibers extending across said slits prior to expansion of said sheet of fibrous material.

12. In some examples, the expandable slit sheet paper product of 10 further includes that greater than 80% of said slits are free of connecting fibers extending across said slits prior to expansion of said sheet of fibrous material.

13. In some examples, the expandable slit sheet paper product of 10 further includes that greater than 90% of said slits are free of connecting fibers extending across said slits prior to expansion of said sheet of fibrous material.

14. In some examples, the expandable slit sheet paper product of 10 further includes that greater than 95% of said slits are free of connecting fibers extending across said slits prior to expansion of said sheet of fibrous material.

15. In some examples, the expandable slit sheet paper product of 10 further includes that greater than 97.5% of said slits are free of connecting fibers extending across said slits prior to expansion of said sheet of fibrous material.

16. In some examples, the expandable slit sheet paper product of 10 further includes that greater than 99% of said slits are free of connecting fibers extending across said slits prior to expansion of said sheet of fibrous material.

17. In some examples, the expandable slit sheet paper product of 9 further includes that said sheet of fibrous material is substantially free of compressed regions adjacent to said slits caused by crush-cutting forces causing compression of the sheet of fibrous material.

18. In some examples, the expandable slit sheet paper product of 9, or any other of the preceding 1-17, further includes that said expandable slit sheet material is a pallet wrap.

19. In some further examples, in combination:
a) the expandable slit sheet paper product of 18; and
b) a pallet around which said expandable slit sheet paper product is wrapped.

20. In some examples, the expandable slit sheet paper product of 9, or any other of 1-17, further includes that said expandable slit sheet material is configured to provide cushioning within a wall of an envelope or mailer.

21. In some further examples, in combination:
a) the expandable slit sheet paper product of 20; and
b) an envelope or mailer having said expandable slit sheet paper product within a wall of the envelope or mailer for cushioning.

22. In some examples, the expandable slit sheet paper product of 9, or any other of 1-17, further including said expandable slit sheet material is configured to provide a void-fill upon expansion.

23. In some further examples, in combination:
a) the expandable slit sheet paper product of 22; and
b) a container or box having said expandable slit sheet paper contained therein as void-fill.

24. According to some other embodiments, a method of upgrading a system for making expandable slit sheet material is provided that includes:
a) providing a system for making expandable slit sheet material by pressing a die member having an array of blades against an anvil member with a sheet of material between said die member and said anvil so that said sheet of material is cut by said blades to form an array of slits;
b) providing an intermediary material layer upon said anvil such that during pressing of the die member having said array of blades against said anvil member with a sheet of material between said die member and said anvil so that said sheet of material is cut by said blades to form an array of slits, said blades also pass through said sheet of material and penetrate said intermediary material layer.

25. In some examples, the method of 24, or any other of the preceding 1-23, or any of the following 39-46, wherein said intermediary material layer is a plastic or elastomeric layer.

26. In some examples, the method of 24, or any other of the preceding 1-23, or any of the following 39-46, wherein said intermediate material layer is attached to said anvil member with an adhesive.

27. In some examples, the method of 24, or any other of the preceding 1-23, or any of the following 39-46, wherein said intermediate material layer is between about 0.25 mil and 10 mil thick.

28. In some examples, the method of 24, or any other of the preceding 1-23, or any of the following 39-46, wherein said intermediate material layer is between about 0.75 mil and 8 mil thick.

29. In some examples, the method of 24, or any other of the preceding 1-23, or any of the following 39-46, wherein said intermediate material layer is between about 1.5 mil and 7 mil thick.

30. In some examples, the method of 24, or any other of the preceding 1-23, or any of the following 39-46, wherein said intermediate material layer is between about 2.0 mil and 6 mil thick.

31. In some examples, the method of 24, or any other of the preceding 1-23, or any of the following 39-46, wherein said intermediate material layer is between about 2.5 mil and 5 mil thick.

32. In some examples, the method of 24, or any other of the preceding 1-23, or any of the following 39-46, wherein said intermediate material layer is form from one or more of:
a) a fibrous material;
b) a paper material;
c) a natural material;
d) a synthetic material;
e) a polymeric material;
f) an elastomeric material;
g) a plastic material;
h) a metal (for example, a metal having a sufficient softness such that said blades penetrate said therein, such as for example, in some illustrative examples, employing an aluminum material for said intermediate layer and stainless steel for said blades).

33. In some examples, the method of 24, or any other of the preceding 1-23, or any of the following 39-46, wherein said intermediate material layer is formed of a material of sufficient softness that said blades penetrate into said intermediate material layer.

34. In some examples, any of the preceding 1-33, or any of the following 39-46, wherein said blades have a maximum width (BWm) at a location that penetrates a sheet of material of less than less than 40 mils, and, in some embodiments, the blades B can have a width (BWm) of less than 30 mils, and, in some embodiments, the blades B can have a width (BWm) of less than 25 mils, and, in some embodiments, the blades B can have a width (BWm) of less than 20 mils, and, in some embodiments, the blades B can have a width (BWm) of less than 15 mils, and, in some embodiments, the blades B can have a width (BWm) of less than 10 mils, and, in some embodiments, the blades B can have a width (BWm) of less than 5 mils.

35. In some examples, any of the preceding 1-34, or any of the following 39-46, wherein said blades have an angle α (alpha) of less than 35 degrees, and, in some embodiments, less than 25 degrees, and, in some embodiments, less than 15 degrees, and, in some embodiments, less than 10 degrees, and, in some embodiments, less than 5 degrees.

36. In some examples, any of the preceding 1-35, or any of the following 39-46, wherein said blades have a bevel on both sides of the blade.

37. In some examples, any of the preceding 1-35, wherein said blades have a bevel on only one side of the blade.

38. In some examples, any of the preceding 1-37, wherein said blades have a bevel angle θ (theta) of greater than 55 degrees, and, in some embodiments, greater than 65 degrees, and, in some embodiments, greater than 75 degrees, and, in some embodiments, greater than 80 degrees, and, in some embodiments, greater than 85 degrees.

39. In some other embodiments, a method includes:
forming a male and female die pair for making expandable slit sheet paper by:
providing a first male die member having an array of blades for forming an array of slits within a paper sheet to form an expandable slit sheet paper;
pressing said first male die member against a second member, said second member preferably having a rigid member with an intermediary material layer along a peripheral side of said rigid member facing said first die member, such that said blades penetrate said intermediary material layer and create an array of corresponding female die holes, whereby the second member is formed to a female die member, and withdrawing said blades from said corresponding female die holes.

40. In some examples, the preceding 39 further includes:
wherein said step of pressing is performed either a) without a sheet of paper between said first male die member and said second member such as to be prior to forming of any expandable slit sheet paper with the male and female die pair of said first male die member and said second female die member; or b) with a sheet of paper between said first male die member and said second member such as to concurrently form an initial expandable slit sheet paper with said sheet of paper concurrently with formation of the male and female die pair of said first male die member and said second female die member.

41. In some examples, any of the preceding 1-40 further include that the expandable slit sheet paper includes an array of slits with a width of less than 0.8 inches, or, in other embodiments, less than 0.7 inches, or, in other embodiments, less than 0.6 inches, or, in other embodiments, less than 0.5 inches, or, in other embodiments, less than 0.4 inches, or, in other embodiments, less than 0.3 inches, or, in other embodiments, between about 0.2 to 0.8 inches, or, in other embodiments, between about 0.35 to 0.55 inches, or, in other embodiments, between about 0.2 to 0.45 inches, or, in other embodiments, between about 0.2 to 0.35 inches, or, in other embodiments, between about 0.2 to 0.3 inches.

42. In some examples, any of the preceding 1-41 further include that the expandable slit sheet paper includes an array of slits with a spacing between rows of slits of about ⅛ inch or less.

43. In some examples, any of the preceding 1-42 further include that the expandable slit sheet paper includes an array of slits that expand into generally hexagonal cells upon expansion.

44. In some examples, the method of any of the preceding 39-43 further include that said holes of said female die holes are formed such as to correspond substantially to the shape and size of the respective blades.

45. In some examples, the method of any of the preceding 39-44 further include that said intermediary material layer plasticly deforms upon penetration of said blades such that said holes of said female die holes are formed such as to correspond substantially to the shape and size of the respective blades.

46. In some examples, the method of any of the preceding 39-45 further including that the respective female die holes formed within the intermediary material layer IM have a width substantially corresponding to a width (BWm) of a corresponding blade upon penetration and withdrawal of the single respective blade B, or, in some preferred embodiments, greater than ½ of the width (BWm) of the corresponding blade, or, in some preferred embodiments, greater than ¾ of the width (BWm) of the corresponding blade, or, in some preferred embodiments, 6/7 of the width (BWm) of the corresponding blade, or, in some preferred embodiments, greater than 15/16 of the width (BWm) of the corresponding blade.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

This patent or application file contains at least one drawing executed in color. Copies of this patent or patent application publication with color drawing(s) will be provided by the Office upon request and payment of the necessary fee. The preferred embodiments of the present invention are shown by a way of example, and not limitation, in the accompanying figures, in which:

FIG. 1 is a right-side perspective view of a first embodiment of the present invention showing a slit-cutting apparatus configured to cut an array of slits within a sheet of material employing a die and anvil, along with an intermediary material layer on the anvil;

FIG. 2 is a left-side perspective view of the first embodiment shown in FIG. 1 depicting an intermediary material layer being applied to a surface of the anvil;

FIG. 3 is a photograph showing an illustrative intermediary material that can be employed in some embodiments of the invention;

FIG. 4 is a front view of a second embodiment of the present invention, which includes the exemplary intermediary material shown in FIG. 3 wrapped around an anvil in accordance with an illustrative embodiment of the invention;

FIG. 5 is an enlarged/magnified image of an example of the present invention in which a slit cut is formed in a sheet of paper employing an intermediary material, to form an expandable slit sheet material in accordance with an embodiment of the present invention;

FIG. 6 is an enlarged/magnified image of an example of a crush cut slit formed in accordance with the background art, in which the slit is formed by a knife that is employed to cut the paper by pressure force against a rigid surface of an anvil;

FIG. 7 is a schematic diagram showing a side view of a crush-cut system in accordance with the background art;

FIG. 8 is a schematic diagram showing a side view a slit-cut system according to some illustrative embodiments of the present invention employing an intermediary material upon an anvil;

FIG. 9 is a schematic diagram showing a side view another slit-cut system according to some other illustrative embodiments of the present invention;

FIG. 10A is a schematic diagram showing a side view of a blade region of a slit-cut system according to some illustrative embodiments of the present invention;

FIG. 10B is a schematic diagram showing a side view similar to that shown in FIG. 10A, without the blade and with further details related to the intermediary material layer IM according to some embodiments;

FIGS. 10C and 10D are schematic diagrams showing side views of a portion shown in FIG. 10C for explanatory purposes related to, e.g., preferred materials and structure of the intermediary layer;

FIG. 11 is a perspective view of a system for cutting an array of slits in a sheet of paper to form an expandable slit sheet paper, wherein such system for cutting an array of slits in a sheet of paper to form an expandable slit sheet paper is adaptable to incorporate an intermediary material IM layer in accordance with embodiments of the present invention; and

FIG. 12 is a perspective view of an illustrative soft/flexible die according to the background art.

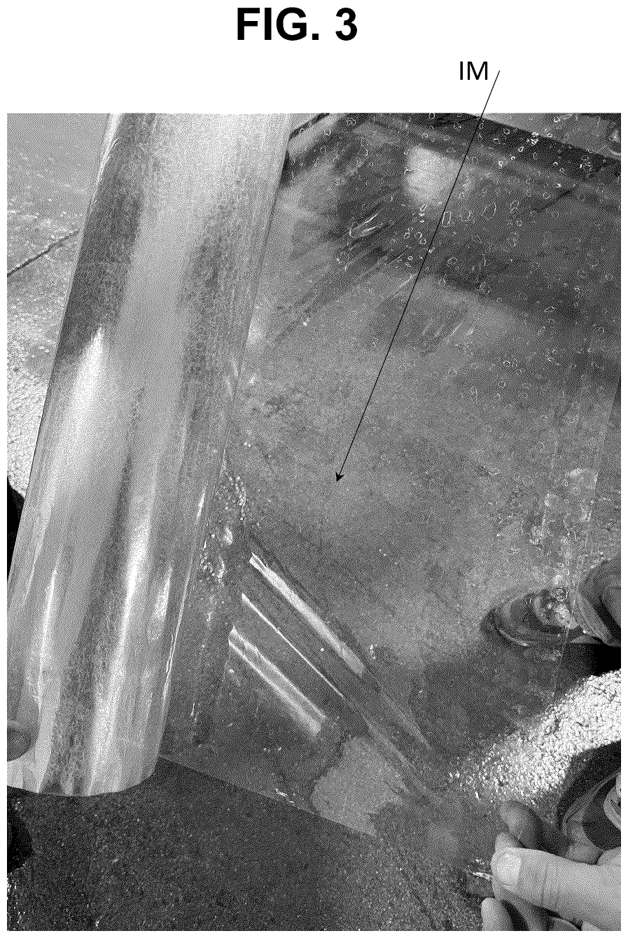

In the attached drawings, FIGS. 3, 4, 11 and 12 are photographs of actual products. Accordingly, these photographs show illustrative examples, to scale, such that these figures show illustrative examples to scale and angles and relative dimensions shown in these figures are as shown in these figures in such illustrative examples. Moreover, in some alternative embodiments, such shown angles and relative dimensions can be varied slightly, such as, e.g., plus or minus 15% in some examples, or plus or minus 10% in some other examples.

### DETAILED DESCRIPTION OF THE PREFERRED EMBODIMENTS

While the present invention may be embodied in many different forms, the illustrative embodiments are described herein with the understanding that the present disclosure is to be considered as providing examples of the principles of the invention and that such examples are not intended to limit the invention to preferred embodiments described herein and/or illustrated herein.

### Introduction to the Preferred Embodiments

The preferred embodiments provide systems and methods for making improved slit sheet material. In the preferred embodiments, novel systems and methods or manufacturing of slit sheet material are provided that greatly alter and improve the slit sheet material formed. In the preferred embodiments, the improved slit sheet material is so far improved over the existing art that the improved slit sheet material has benefits and uses that were not possible with existing art.

In the preferred embodiments, an improved system and method is provided for the die cutting of sheet materials to form expandable slit sheet materials having substantial benefits and improvement over existing systems and methods.

### Background

Die cutting is performed in several ways depending on the technology used and the material type being cut. Thicker items, like corrugated board, is die cut using knives implanted within a cylinder (for rotary cutting) that cuts through and into a soft anvil like a rubber material. Employing soft anvil die cutting causes the blade to be forced, under pressure, through the material to be cut and then into the soft anvil such as to create a complete cut. Among other things, employing such a soft anvil has a shorter lifespan due to the ever-increasing cuts that eventually deform and reduce the diameter of the anvil.

### Die Cutting Technologies Employed in Some Illustrative Embodiments

In some illustrative embodiments, die cutting technologies employed can include some or all of the following components.

Roller (e.g., Magnetic Roller): In some examples, a roller (for example, a magnetic roller) is employed that involves a roller or cylinder to perform rotary die cutting. In some embodiments, a roller is employed that includes a plurality (e.g., an array) of cutting elements (e.g., cutting knives or blades) extending therefrom. In some embodiments, a roller can include a die surrounding the roller or wrapped around the roller. For example, in some embodiments, a flexible die is provided that is wrapped around the roller.

Anvil: In some examples, an anvil is employed that is either reciprocated (such as, e.g., for a flat or planar anvil) or rotated (such as, e.g., for a round or cylindrical anvil), and operates as a component (e.g., a platen) that receives pressure (e.g., that knives or blades press against) as the knives cut through the material that is formed with slits.

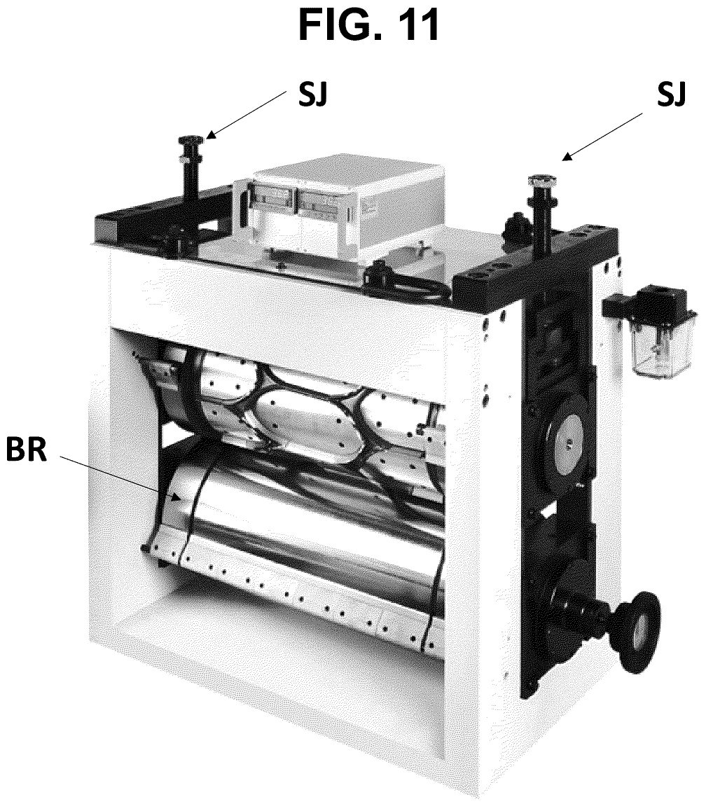

Pressure (e.g., Screw) Jacks: In some examples, in order to apply pressure required between rollers (e.g., having cutting knives or the like) and the anvil, a pressure jack, such as, e.g., a screw jack is employed. In some embodiments, threaded rods are used to apply pressure to both sides of the die cutting and unto the bearers to create the pressure needed to die cut (e.g., to cut a sheet material between the roller and the anvil). By way of illustration, FIG. 11 shows an illustrative system employing screw jacks SJ.

In some illustrative applications, a crush-cut die system is employed that includes a solid die. In some examples, a lower roller is provided that is an anvil (e.g., which is rigid and smooth) and an upper roller is provided that has a die (e.g., with cutters and/or knives thereon); in some embodiments, one or more pressure jack (see, e.g., SJ in FIG. 11; such as, e.g., a screw jack) is employed that is used to apply pressure to the bearers (see, e.g., BR in FIG. 11).

Roll Apex: In some illustrative applications, a location of contact between the roller (e.g., the cutting roll) and the anvil (e.g., the anvil roll) that provides a greatest pressure against one another is at a point of contact between a roll apex of the cutting roll and/or a roll apex of the anvil roll.

### Introduction to the Preferred Embodiments

According to some preferred embodiments of the present invention, an improved cutting system and method is provided for cutting thin materials, such as, e.g., paper, and, most especially, for cutting thin materials, such as, e.g., paper, in a manner to form an array of holes or slits therein, and, most preferably, an array of parallel slits, each having a length of between about 0.1 to 0.8 inches, or, more preferably, between about 0.2 to 0.7 inches, or, more preferably, between about 0.25 and 0.60 inches.

In some illustrative examples, a die cutting roll having an array of knives is operated to bring the knives very close to the anvil (e.g., within one-ten-thousandth of an inch from the anvil, or within another small tolerance distance depending on the thickness of the paper to be cut) such as to effect cutting of a material (e.g., paper) without the die cutting roll ever contacting or touching the anvil such as to prolong the life of the die and the anvil by inhibiting contact forces there-between.

In some illustrative embodiments, the life of the blade can be further enhanced by the type of sharpening that is done during the manufacturing process (e.g., at the end of the manufacturing process). In some examples, the cutting blade can be center beveled (e.g., sharpening from both sides) or side bevel (e.g., sharpening along one side of the cutting blade).

In various embodiments, the sharpening method employed and the type of technology used (e.g., whether a solid die, a flexible die, etc.) will benefit from the use and implementation of aspects of the present invention as described herein.

### Summary of Aspects of the Preferred Embodiments

According to some of the preferred embodiments of the present invention, an intermediary material layer IM is placed upon the anvil. In the preferred embodiments, this intermediary material layer advantageously creates a hybrid of a soft anvil and a hard anvil die cutting method. In the preferred embodiments, the intermediary material layer is soft and pliable such as to be able to be bent around the periphery of the anvil. In the preferred embodiments, the intermediary material layer can be adhered to the anvil with the use of a mild adhesive. However, the intermediary material layer can be connected in a variety of ways, such as, e.g., via a mechanical connection (e.g., clamps, rivets, etc.), chemically adhered, meltedly or heatedly adhered, statically adhered, and/or otherwise mounted to or attached to the anvil. In operation, the knives of the cutting blade preferably penetrate into the intermediary material layer such as to create and provide slots within the intermediary material layer that the knives or blades enters, guaranteeing a cut through the material (e.g., paper or the like), but the knives or blades, advantageously, does not touch the anvil such as to provide a longer life of the anvil, along with a longer tooling life, along with lower die-cutting pressures, and/or along with inhibiting lateral shifting of the die (e.g., of a flexible die or the like), and/or along with other advantages and/or benefits described herein.

### Problems with Crush-Cutting Systems Addressed by Some Embodiments of the Present Invention

According to some of the preferred embodiments, there are four aspects of crush-cutting that can be substantially improved upon with embodiments of the present invention.

1. Precision Machining:

The first aspect is precision machining. For example, according to some of the preferred embodiments, a material that is being cut can include, e.g., a paper that has a thickness of between about 0.0025″-0.014″ (i.e., 0.0025 to 0.014 inches). Although some preferred embodiments involve cutting of such materials having a thickness within the foregoing range, it should be appreciated that the present invention can be employed in the context of a wider range of thicknesses of materials, including cutting into materials of a wide variety of ranges, including materials having thicknesses of less than 0.0025 inches and/or materials of greater than 0.014 inches, such as, e.g., materials having thickness of between 0.0005 to 0.0025 inches or smaller and/or materials having thicknesses of 0.014 to 0.2 inches or larger.

In some of the preferred embodiments, the paper being cut to form an expandable slit sheet paper can be made from any type of paper sheet, such as, e.g., a paper made with fibers, such as, e.g., natural fibers, plant-based fibers, cellulose fibers, or the like. In some embodiments, the paper 1 is a Kraft paper. In some preferred embodiments, the paper 1 is made of a recyclable paper material. In some embodiments, the paper 1 can be made entirely from recycled paper. In some embodiments, the paper 1 can be made entirely from virgin, non-recycled, paper. In some embodiments, the paper 1 can be made with a combination of recycled paper and virgin paper. In some embodiments, the paper is a paper that weighs greater than 25 pounds (lbs.) per 3,000 square feet (i.e., 25 #paper). In some embodiments, the paper is a paper that weighs greater than 30 pounds per 3,000 square feet (i.e., 30 #paper). In some embodiments, the paper is a paper that weighs greater than 40 pounds per 3,000 square feet (i.e., 40 #paper). In some embodiments, the paper is a paper that weighs greater than 40 pounds per 3,000 square feet (i.e., 40 #paper). In some embodiments, the paper is a paper that weighs greater than 50 pounds per 3,000 square feet (i.e., 50 #paper). In some embodiments, the paper is a paper that weighs greater than 60 pounds per 3,000 square feet (i.e., 60 #paper). In some embodiments, the paper is a paper that weighs greater than 70 pounds per 3,000 square feet (i.e., 70 #paper). In some embodiments, the paper is a paper that weighs between about 30 pounds per 3,000 square feet to 70 pounds per 3,000 square feet. In some embodiments, the paper is a paper that weighs between about 40 pounds per 3,000 square feet to 60 pounds per 3,000 square feet. In some embodiments, the paper is a paper that weighs between about 35 pounds per 3,000 square feet to 55 pounds per 3,000 square feet. In some embodiments, the paper is a paper that weighs between about 45 pounds per 3,000 square feet to 55 pounds per 3,000 square feet. In some embodiments, the paper is a paper that weighs between about 30 pounds per 3,000 square feet to 70 pounds per 3,000 square feet. In some embodiments, the paper is a paper that weighs between about 50 pounds per 3,000 square feet to 60 pounds per 3,000 square feet.

In some embodiments, the paper 1 is an extensible paper, such as, e.g., any of the extensible papers describe in U.S. Pat. No. 10,669,086, the entire disclosure of which is incorporated herein by reference as if recited herein in full. For example, in some embodiments, the paper is an extensible paper with an extensible range, in a pre-slit condition of between about 3 to 20% in the machine direction, or, in some preferred embodiments, about 4 to 20% in the machine direction, or, in some preferred embodiments, about 5 to 20% in the machine direction, or, in some preferred embodiments, about 6 to 20% in the machine direction. In some preferred embodiments, the paper is a Clupak paper, as described in said U.S. Pat. No. 10,669,086.

In order to provide a complete cut through the material, the knives or blades preferably penetrate the material to a point where the crush-cut bursts the remaining paper fibers from the pressure of the knife cutting into the paper. In some instances, the distance that the knives and/or blades extend from the anvil (i.e., the distance that the knives and/or blades are separated from the anvil upon full penetration and cutting of the material) is less than or equal to about 0.0001″ in some embodiments (i.e., about 0.0001 inches). However, in various embodiments, the distance that the knives and/or blades extend from the anvil can be substantially less than 0.0001 inches and in various embodiments, the distance that the knives and/or blades extend from the anvil can be substantially greater than 0.0001 inches. For example, in some embodiments, the knives and/or blades can extend to within about 0.0001 to 0.001 inches or even more in some other embodiments. Of course, heavier weight paper will create higher cut and bursting forces at 0.0002″ and above. In order to make sure that all the cutting blades cut evenly requires a high degree of precision machining of the flexible die.

2. Variation:

The second aspect is to have the blades never hit the same spot on the anvil. Towards that end, in some embodiments, the diameter of the anvil and the roller (e.g., magnetic roller) are of different diameters. If a blade were to consistently land at a same relative spot or position on the anvil, then eventually high pressures of the die cutting and forces via the blades, the paper, etc., would affect the machinery, e.g., etching the anvil, etc., and wear the machinery, including the anvil, gears, etc., sooner.

3. Non-Perpendicular:

The third aspect is to avoid numerous perpendicular cuts concurrently. That is, it is preferred to avoid additional perpendicular cuts happening simultaneously along the entire apex of the cut. If that happens (i.e., if many perpendicular cuts occur concurrently along the apex), then the pressure can become so high that, in some examples, there can even be a bounce that occurs that literally provides two cuts as the two rollers meet again. (NOTE: The present inventor discovered that this bounce-back created paper debris or “confetti” in prior machines creating existing expandable slit sheet paper products) remember that crush cutting requires hardened and inflexible rollers.

To eliminate this bounce, the pattern of the die is angled (e.g., about 0.5-2 degrees) such that the pattern passes through the apex at an angle (e.g., at an angle to a line in the direction of pressure applied). This slight angle can help provide a point of cutting rather than a line of cutting, greatly reducing the pressure required to cut the material. This offset cutting has the tendency to apply pressure to the magnetic die to shift to one side of the magnetic roller (e.g., like a tire out of alignment on a car). In some instances, in which the shifting happens to the point at which the magnetic die gets underneath the bearer, then multiple parts can become destroyed.

4. Pressure:

The fourth aspect is the precise amount of pressure used so that the knives do not touch the anvil but perform the precision cutting required. In some embodiments, the application of pressure to the bearers deforms them at the apex which allows the knives to penetrate lower than if no pressure were applied. This deformation is much like a tire on a car having a flat spot where it touches the road. In this case, the flat spot can only be viewed with a precision instrument that can see this deformation in changes in diameter.

The accidental over adjustment of a screw jack can cause immediate die failure. To avoid this, the pressure applied is done very gradually with constant checking of the paper die cutting quality. As the die wears, the pressure needs to be increased, continuously increased. At a certain point, the blade has worn to a flat area that is too large to make a clean cut, regardless of the amount of pressure applied, and the die needs to be changed.

### Features, Advantages and Benefits of the Preferred Aspects of the Preferred Embodiments

In the preferred embodiments, and improved system and method is provided that can (1) improve the overall manufacturing methods for making expandable slit sheet material (e.g., reducing costs, improving quality, improving consistency, improving machinery lifetime and consistency, improving consistency, reducing difficulties for management of equipment, etc.); and/or (2) improve the overall quality of expandable slit sheet paper produced (e.g., improving the cleanness and accuracy of cutting, creating expandable slit-sheet material that i) can be opened at reduced forces, ii) can create better cushioning, iii) that can achieve smaller-size slit openings, and/or iv) that can enable the creation of products previously unable to be achieved by existing systems, including novel void-fill products, novel pallet-wrap products, and all other novel products set forth and described in the above-incorporated patents and applications of the present inventor, incorporated into this application).

Notably, aspects of the present invention in combination with aspects of the present inventor's technology within above-incorporated patents and application of the present inventor, achieve extraordinarily superior products, with advantages far exceeding that of the existing art. Notably, the preferred embodiments of the present invention, which involve novel mechanisms for making (e.g., cutting) expandable slit sheet paper are completely synergistic with all of the technologies within all of the above-incorporated patents and applications of the present inventor. By way of example, employing the present methods for forming expandable slit sheet material with extensible papers (e.g., including of the ranges of extensibility described in the patents and applications of the present inventor) achieves extraordinary synergistic advantages.

As discussed above, in the preferred embodiments, in order to a) greatly enhance the manufacturing process and/or b) to greatly improve the product manufactured, in some of the preferred embodiments, an intermediary material layer IM is placed upon an anvil. In the preferred embodiments, the anvil is a rigid or substantially rigid member upon which the intermediary material layer is applied.

In the preferred embodiments, this intermediary material layer advantageously creates a hybrid of a soft anvil and a hard anvil die cutting method. In the preferred embodiments, the intermediary material layer is soft and pliable such as to be able to be bent around the periphery of the anvil. In the preferred embodiments, the intermediary material layer can be adhered to the anvil with the use of a mild adhesive. However, the intermediary material layer can be connected in a variety of ways, such as, e.g., via a mechanical connection (e.g., clamps, rivets, etc.), chemically adhered, meltedly or heatedly adhered, statically adhered, and/or otherwise mounted to or attached to the anvil.

In the preferred embodiments, by adding a thin intermediary sheet (e.g., intermediary material layer) to a rigid or substantially rigid anvil, a number of substantial benefits can be achieved by, e.g., providing such a novel technology that advantageously can achieve one or more of the following benefits.

1. Firstly, the technology can greatly reduce the pressure required to provide a complete and clean cut. This can, thus, achieve much better product due to the increased cleanness of cuts in combination with the reduction of pressure, which, advantageously, also helps to ensure the continued and consistent quality of the cuts. By way of example, the present inventor took an existing die operating at 1500 pounds per square inch (psi) to provide a complete cut, applied an intermediary material layer according to an embodiment of the present invention around the existing anvil and the pressure of the system was reduced to 500 pounds.

2. Secondly, this technology can provide a very easy methodology to upgrade existing systems and devices. Notably, an intermediate sheet (e.g., intermediary material layer) according to the preferred embodiments can readily be applied to most existing systems. And, more notably, such an intermediary sheet can be readily applied without modification of existing systems, with extraordinarily low cost, without harming the device, but, in fact, increasing the longevity of the device, and, even more notably, also creating a product having substantial advantages and improvements over the existing art. Thus, the preferred embodiments of the present invention, reduces costs, increases longevity of existing systems, can be nearly instantly implemented at minimal cost to an existing system, can be repeatedly implemented, and produces a far superior product.

3. Thirdly, the above-noted pressure reduction provides greatly extended life to the machinery, including, e.g., the anvil and the roller or the like (e.g., a magnetic roller). Among other things, these advantages stem from, e.g., the fact that it does this by less deformation of the bearers, reducing heat and wear that would otherwise impact the machinery (e.g., reduce the diameter) over time. In some embodiments, the present invention helps to overcome problems of existing devices by increasing the distance required to make a final cut—e.g., increasing the blade life by reducing the pressure against the knife.

4. Fourthly, the preferred embodiments also help to inhibit die shifting that can lead to serious problems during manufacturing, such as, e.g., even creating a catastrophic failure due to the skewing of a die that forces the die to one side. In the context of die equipment having arrays of knives for forming expandable slit sheet paper, the present inventor has determined that due to the number of rows of knives on a slit sheet pattern in some examples, the number of knives interacting with the paper at a given time is about 3 (or, in some other examples, within a range of about 2-5) and with a system for forming a pallet wrap (see the above-noted 63/190,025) the number of knives interacting with the paper at a given time is about 7 (or, in some other examples, within a range of about 4-10). The present inventor has discovered that this multi-knife row interaction as the knives move to the apex creates a lateral movement of the die; however, the present inventor has discovered that implementing of an intermediary material layer (such as, e.g., a thin sheet of polyester) can, e.g., lock in the multiple rows and inhibit or eliminate this lateral movement.

5. Fifthly, the preferred embodiments also help to reduce the forces applied (e.g., against the anvil) and, thus, greatly reducing the etching that naturally occurs with the crush-cutting technology. The present inventor has found that existing anvils for forming existing expandable slit sheet paper typically only lasts for about 6 months and costs, e.g., thousands of dollars (e.g., about $2,800.00) to replace, and the inventor has found that depending on the bearer wear that occurs simultaneously, this wear can cause the anvil to need to be replaced, in most instances, rather than being machined back to a required tolerance.

6. Sixthly, the preferred embodiments also help to greatly extending machinery life, including die life. By way of example, the present inventor has found that the die life for existing machinery for making expandable slit sheet paper with a new anvil is about 5000-7000 rolls of finished product (e.g., finished expandable slit sheet paper material), and that as the anvil ages this reduces to 1000 rolls. However, the present inventor has also discovered that in such an existing system, by simply adding an intermediary material layer in accordance with an embodiment of the present invention (e.g., adding it to the latter-noted existing machinery), the dies can last much longer, and can even last, e.g., for 15000 rolls or more.

7. Seventhly, the preferred embodiments also help to achieve all the advantages herein, while simultaneously reducing down-time and the manual labor required to replace machinery components (such as, e.g., dies, anvils, etc.).

8. Eighthly, the preferred embodiments also help to achieve all the advantages herein, while simultaneously greatly reducing the quality inspection time between rolls increasing production.

9. Ninthly, the preferred embodiments also help to greatly reduce costs related to operation of the machinery. Notably, the present inventor's cost analyses reflected reduction of overall cost by up to 10% or more.

### Illustrative Modes of Implementing or Carrying Out Illustrative Embodiments of the Invention

According to some illustrative embodiments, an existing die system for manufacture of expandable slit sheet paper material can be upgraded to an embodiment of the present invention by adding an intermediary material layer IM according to an embodiment of the present invention, as follows.

1. First, a matched magnetic roll diameter to the anvil roll diameter is preferably used in some preferred implementations. In an exemplary implementation, the present inventor used ⅛″ pitch diameter gears that match a ⅛″ distance between the rolls of knives. The present inventor did not need to use the same diameters; however, but advantageously used the same pitch to align the knives and the slots created in the intermediary material layer. In some illustrative examples, this ⅛″ is also a distance between the gears and, also, matches a distance between the cutting rows of blades (e.g., in embodiments that create expandable slit sheet paper having ⅛″ row spacings).

2. Second, the magnetic die is lifted away from the anvil.

3. Third, the anvil is cleaned (e.g., dust particles or debris can provide raised or high spots when the intermediary material layer is applied).

4. Forth, the intermediary material layer IM is applied to the anvil. In some illustrative and non-limiting embodiments, the intermediary material layer can include, e.g., about 0.001″ thick sheet of polyester applied with a mild adhesive.

5. Fifth, the magnetic roller, with the die attached, is lowered onto the anvil with an initial pressure that makes cuts into the intermediate material layer IM, which cuts result in the creation of receiving holes within the intermediate material layer (e.g., slits or grooves formed into the intermediate material by the knives or blades of the roller).

6. Sixth, paper or material to be slit to form an expandable slit sheet paper or material is added to the machine, and the pressure of the machinery is adjusted to make complete cuts through the paper or material with the knives or blades penetrating through the paper or material and extending into the corresponding cuts made in step 5 above within the intermediate material layer.

7. Seventh, after the device has been in operation for a period of time and creating expandable slit sheet material employing the improved machinery with the intermediary material layer IM, then, at a desired point in time, the intermediary material layer can be simply removed and replaced with a new sheet of intermediary material layer as desired. For example, when the die life ends (e.g., if there is damage to the die or machinery, and/or the product quality deteriorates), the intermediary material layer IM can be simply removed and a new sheet of intermediary material can be applied. Notably, even if the knives or blades of the die have shifted slightly, replacement of the intermediary material layer IM can result in a “re-calibration” or “re-establishment” of the alignment between the knives and the receiving holes or cuts within the intermediary material layer IM because the newly applied intermediary material layer IM will be newly cut in accordance with the current positioning of the knives or blades. Thus, the system very advantageously helps to maintain high precision and accuracy despite the use of a die having numerous knives or blades that may shift slightly in positioning or the like.

### Additional Advantageous Features of Some of the Preferred Embodiments

According to some embodiments, due to the great reduction in forces applied to the knives or blades (e.g., by employment of an intermediary material layer IM member), the knives or blades can be re-structured in a manner to enhance cutting quality, without substantial concern for ability of the knives or blades to withstand substantial forces. Thus, for example, the knives or blades can be made substantially sharper (e.g., thinner) so as to freely slice and sever sheet material (e.g., to form expandable slit sheet material). Moreover, as the tips of the knives or blades do not press against a hard anvil surface and do not press paper material against a hard anvil surface, but against the intermediary material layer, the tips of the knives can be configured more-so for enhanced cutting ability and less-so for enhanced structural rigidity and strength to avoid breakage and/or deformation.

Illustrative Intermediate Material Layer Materials Employed

According to some embodiments, the intermediary material layer IM can be made with an plastic, elastomeric material, a polymeric material, a rubber material, or with another non-rigid material (such as, e.g., for example, a paper material, fabric materials, soft wood material, cardboard material, a Styrofoam or other foam material, and/or another non-rigid material). In some embodiments, the intermediary material layer IM can be made with metals or other materials, provided that the hardness of the intermediary material layer IM is sufficiently soft such that blades can penetrate into said intermediate material layer. By way of example, in some illustrative embodiments the intermediary material layer IM can be made of aluminum. For example, in some embodiments, the intermediary material layer IM can be made from an aluminum foil layer or sheet that can be, e.g., wrapped around an anvil in accordance with embodiments described herein. In some other illustrative embodiments, other softer metals (e.g., other metals having a Mohs scale of hardness that is sufficiently low to allow the blades to penetrate therein). By way of example, in other embodiments, the intermediary material layer IM can be made with one or more of the following metals:
a) lead,
b) gold,
c) silver,
d) tin,
e) zinc,
f) aluminum,
g) thorium,
h) copper,
i) brass,
j) bronze,
k) nickel.

In some illustrative embodiments, an intermediary material layer (IM) can be made with a metal having a Mohs scale of hardness value of about 4.0 or less, or, in some embodiments, about 3.5 or less, or, in some embodiments, about 3.0 or less, or, in some embodiments, about 2.5 or less. In some illustrative embodiments, an intermediary material layer (IM) can be made with a metal having a Mohs scale of hardness value of between about 1.0 to 4.0, or, in some embodiments, between about 1.5 to 3.75, or, in some embodiments, between about 2.0 to 3.5, or, in some embodiments, between about 2.25 to 3.25, or, in some embodiments, between about 2.5 to 3.0.

As indicated herein, in preferred embodiments, the intermediary material layer IM should have a sufficient softness in comparison to the hardness of the blades such that the blades can penetrate within the intermediary material layer IM as set forth in various embodiments of the invention described herein.

In some preferred embodiments, in the event that the dimensions of the slits to be formed within the expandable slit sheet paper are smaller (such as, e.g., when slits are provided with lengths of less than about 0.5 inches, or, more notably, when slits are provided with lengths of less than about 0.45 inches, or, more notably, when slits are provided with lengths of less than about 0.4 inches, or, more notably, when slits are provided with lengths of less than about 0.35 inches, or, more notably, when slits are provided with lengths of less than about 0.30 inches, or, more notably, when slits are provided with lengths of about 0.25 inches, or, more notably, when slits are provided with lengths of less than about 0.25 inches), the material of the intermediary material layer (IM) is preferably made with a softer metal, such as, e.g., aluminum. Among other things, in contrast to some plastics or other potential materials to be employed as a intermediary material layer (IM), a softer metal, such as, e.g., aluminum, can facilitate formation of finer slit patterns with tighter (e.g., smaller) distances between slits without damage, such as, e.g., crumbling, breakage or the like, of the intermediary material layer (IM) upon penetration of the blades.

Although embodiments of the present invention can be applied within various expandable slit sheet papers having various patterns of slits, in some preferred embodiments, the dimensions of the expandable slit sheet paper are proportionally reduced from an expandable slit sheet paper having a 0.5″ slit length, a ⅛″ (0.125 inch) spacing between rows, and a spacing between slits within the same row (i.e., land length) of 3/16″ (0.1875 inch) as follows: a) the row spacing is proportionally reduced by a ratio SL(new)/0.5 and b) the slit spacing is set at SL(new) multiplied divided by 2.6667. For example, some preferred embodiments include dimensions as set forth below Table A:

| | Slit Length (SL) | | Slit Spacing (SS) | | Row Spacing (RS) | |
|---|---|---|---|---|---|---|
| Example A | 0.45 | inches | 0.1687 | inches | 0.1125 | inches |
| Example B | 0.425 | inches | 0.1594 | inches | 0.1063 | inches |
| Example C | 0.40 | inches | 0.1500 | inches | 0.1000 | inches |
| Example D | 0.375 | inches | 0.1406 | inches | 0.09375 | inches |
| Example E | 0.35 | inches | 0.13125 | inches | 0.0875 | inches |
| Example F | 0.325 | inches | 0.1219 | inches | 0.0813 | inches |
| Example G | 0.30 | inches | 0.1125 | inches | 0.0750 | inches |
| Example H | 0.275 | inches | 0.1031 | inches | 0.0688 | inches |
| Example I | 0.25 | inches | 0.09375 | inches | 0.0625 | inches |

In some other embodiments, the slit lengths can be greater than 0.5 inches, while in some other embodiments, the slit lengths can be smaller than 0.25 inches. Similarly, in some embodiments, the slit spacing (i.e., distance between slits within a same row of slits) can be greater than 0.1687 inches, while in some other embodiments, the slit spacing can be less than 0.09375 inches. Similarly, in some embodiments, the slit row spacing (i.e., distance between slits in adjacent rows of slits) can be greater than 0.1125 inches, while in some other embodiments, the row spacing can be less than 0.0625 inches.

In some illustrative embodiments of the present invention, expandable slit sheet papers can be created with substantially smaller slit sizes than that enabled by the background art.

Although a variety of films or layers (e.g., laminates) can be employed for the material of the intermediary material layer IM, plastics can be more preferable, in many contexts, than many other types layers, such as paper, etc., due to, e.g., the greater ease to remove and/or replace such plastic films or layers. Additionally, in some embodiments, the intermediary material layer can have a plurality of layers or sub-layers. For example, in some embodiments (as described herein), a sheet of material can be wrapped around an anvil or the like to create a plurality of layers. In some other examples, the intermediary material layer IM can also include a plurality of layers of differing materials, such as, e.g., materials having different degrees of softness, and/or other qualities.

In some illustrative embodiments, the intermediary material layer IM is made with a thermoplastic material. In some embodiments, the intermediary material layer is made with polyester, such as, e.g., polyethylene terephthalate (PET). In some embodiments, the intermediary material layer (e.g., polyester) can be made with natural materials (e.g., natural polyesters) and/or synthetic materials (e.g., synthetic polyesters).

In the preferred embodiments, the intermediary material layer IM is relatively soft in comparison to the material of the knives or blades, such that the knives or blades relatively freely penetrate the intermediary material layer IM.

In the preferred embodiments, the intermediary material layer IM is flowable, cuttable, bendable, and/or deformable such as to enable penetration by the knives or blades. In some examples, the intermediary material layer IM is deformable (e.g., plasticly deformable) upon penetration of the knives or blades, such that the knives or blades create and leave remaining recesses or grooves within the intermediary material layer that are formed in the intermediary material layer due to deformation (e.g., plastic deformation) of the intermediary material layer upon impingement and penetration of the knives or blades. In some embodiments, the intermediary material layer is flowable, cuttable and/or bendable such that the knives or blades penetrate the intermediary material layer upon impingement and penetration, but wherein due to flowability, elasticity and/or other qualities the intermediary material layer, recesses or grooves are either not left within the intermediary material layer or substantially reclose or reduce in size or configuration after the knives or blades are withdrawn from penetration into the intermediary material layer.

In the preferred embodiments, the intermediary material layer IM is firm enough to support the material being cut (e.g., a paper being cut to form an expandable slit sheet paper) alongside a support surface (e.g., top surface) of the intermediary material layer (which surface of the intermediary material can be, e.g., a substantially arcuate surface corresponding to the curvature of an anvil roller, a planar surface in some embodiments, or another surface configuration), while being flexible or soft enough to allow the knives or blades to penetrate the intermediary material layer IM without substantially causing the support surface of the intermediary material layer to bend or otherwise move, whereby enabling the knives or blades to cut through the material being cut (e.g., paper being cut to form an expandable slit sheet paper), due to the pressure of the knives or blades impinging an outer surface of the material being cut while an inner surface of the material being cut is supported alongside said support surface of the intermediary material layer IM.

In the preferred embodiments, the intermediary material layer is, thus, not made with a rigid material, such as, e.g., a metal or a rigid plastic or the like, which cannot both a) support the material being cut and b) allow penetration of the knives or blades into the intermediary material.

In some examples, the intermediary material layer can be made with any of the materials described herein and can have a thickness of between about 0.25 mil and 10 mil. In some preferred embodiments, the intermediary material layer can have a thickness of between about 0.50 mil and 9 mil. In some preferred embodiments, the intermediary material layer can have a thickness of between about 0.75 mil and 8 mil. In some preferred embodiments, the intermediary material layer can have a thickness of between about 1.0 mil and 6 mil. In some preferred embodiments, the intermediary material layer can have a thickness of between about 1.5 mil and 5.5 mil. In some preferred embodiments, the intermediary material layer can have a thickness of between about 2.0 mil and 5.25 mil. In some preferred embodiments, the intermediary material layer can have a thickness of between about 2.5 mil and 5 mil. In some preferred embodiments, the intermediary material layer can have a thickness of between about 3.0 mil and 4.75 mil.

In some examples, the intermediary material layer has a thickness of at least 0.25 mil, while, in some examples, the intermediary material layer has a thickness of at least 0.5 mil, while, in some examples, the intermediary material layer has a thickness of at least 0.75 mil, while, in some examples, the intermediary material layer has a thickness of at least 1.0 mil, while, in some examples, the intermediary material layer has a thickness of at least 1.25 mil, while, in some examples, the intermediary material layer has a thickness of at least 1.5 mil, while, in some examples, the intermediary material layer has a thickness of at least 1.75 mil, while, in some examples, the intermediary material layer has a thickness of at least 2.00 mil, while, in some examples, the intermediary material layer has a thickness of at least 2.25 mil, while, in some examples, the intermediary material layer has a thickness of at least 2.5 mil, while, in some examples, the intermediary material layer has a thickness of at least 2.75 mil, while, in some examples, the intermediary material layer has a thickness of at least 3.00 mil, while, in some examples, the intermediary material layer has a thickness of at least 3.25 mil, while, in some examples, the intermediary material layer has a thickness of at least 3.5 mil, while, in some examples, the intermediary material layer has a thickness of at least 3.75 mil, while, in some examples, the intermediary material layer has a thickness of at least 4.00 mil.

In some embodiments, although the intermediary material layer can have virtually any maximum thickness in some embodiments, in some preferred embodiments, when the intermediary material layer is a relatively soft material, as the thickness of the intermediary material layer increases, the ability of the knives to freely cut and penetrate the intermediary material layer can be inhibited due to flexibility of the intermediary material layer if the thickness of the intermediary material layer is increased. For example, the increased thickness can lead to a situation in which the knives or blades cause the intermediary material layer to bend, rather than to be cut or severed by the knives or blades. Thus, for example, in some preferred embodiments, the intermediary material layer has a maximum thickness of less than about 10 mil, while, in some other examples, the intermediary material layer has a maximum thickness of less than about 9 mil, while, in some other examples, the intermediary material layer has a maximum thickness of less than about 8 mil, while, in some other examples, the intermediary material layer has a maximum thickness of less than about 7 mil, while, in some other examples, the intermediary material layer has a maximum thickness of less than about 6 mil, while, in some other examples, the intermediary material layer has a maximum thickness of less than about 5 mil, while, in some other examples, the intermediary material layer has a maximum thickness of less than about 4 mil.

In embodiments in which the intermediary material layer is wound around a roller, such as, e.g., around a substantially cylindrical anvil as in certain embodiments shown in the accompanying figures, then the maximum diameter of the intermediary material layer is dictated by the diameter of the roller or anvil. Towards that end, although the intermediary material layer is preferably applied on a surface of an anvil or the like (which anvil or the like is preferably made of a material having a substantially greater hardness and/or rigidity than that of the intermediary material—such as, e.g., a metal, hard plastic, ceramic and/or other hard and/or rigid material), in some embodiments, the entire or substantially the entire anvil or roller can be made with the intermediary material layer.

In some illustrative embodiments, an intermediary material layer IM can employ a polypropylene material similar to that described at: https://americanroller.com/us/polypropylene-rollers-covers/. As indicated at the above URL, polypropylene is a thermoplastic with better mechanical properties and heat resistance than Polyethylene.

In some illustrative embodiments, an intermediary material layer IM can employ a urethane material similar to that described at: https://americanroller.com/arco/roller-coverings/urethane-coated-rollers/. As indicated at the latter URL, urethanes can be desirable in some applications where cut, abrasion, ozone and/or oil resistance is desired.

In some illustrative and non-limiting embodiments, according to some experimental implementations carried out by the present inventor, the intermediary material layer IM can include a polyester film that is adhesively applied to an anvil (e.g., a rotary anvil), which includes the following illustrative and non-limiting specifications (which specifications relate to a clear general purpose polyester film of Qspac Industries, Inc., product number 916C employed in some illustrative experimental implementations):

| | |
|---|---|
| Product: | Polyester film. |
| Description: | Clear general purpose lamination. |
| Film Thickness: | 1.0 mil (25 mic). |
| Adhesive Thickness: | 0.6 mil (15 mic) pressure sensitive |
| | emulsion acrylic |
| Peel Adhesion to | 16.3 oz/in. (0.42 kg/24 mm) [test method |
| steel: | used: e.g., ASTM 3330, www.astm.org] |
| Tensile Strength: | 25 lb · l/in. (10.7 kg/24 mm) [test method |
| | used: e.g., ASTM D3759, |
| | www.astm.org]. |
| Elongation: | 100% [test method used: e.g., ASTM |
| | D3759, www.astm.org]. |
| Application | 32° F. to 150° F. (0° C. to 65° C.). |
| Temperature: | |

According to some illustrative and non-limiting embodiments, according to some experimental implementations carried out by the present inventor, the above exemplary film of Qspac Industries, Inc., was employed in the context of a rotary anvil employed in a background device configured to make expandable slit sheet paper by the prior “crush-cut method.” Specifically, the above film was applied to the outer surface of the hard metal anvil to provide an intermediary material layer according to preferred embodiments herein.

In this illustrative example, the blade height (BH) of the blades of the rotary cutter were about 22 mils. Upon an initial implementation of a single layer around the anvil, such that the intermediary material layer had a total thickness of 1.0 mil (i.e., due to a single layer being applied to the anvil), the pressure applied between the rotary die and the anvil was substantially reduced. However, the inventor discovered that with the 1 mil thickness, the pressure rose after a period of usage.

Upon a later implementation of two additional layers around the anvil (i.e., for a total of 3 layers) such as to have a total intermediary material layer thickness of about 3 mil, the pressure applied between the rotary die and the anvil was greatly reduced, and remained at a greatly reduced amount.

The present inventor has found that in the context of the latter implementation example, employing between about 2 to 4 layers of film (thus, a thickness of between about 2 to 4 mils) can be effective. Additionally, the present inventor has also found that 4 mils can provide a more desirable thickness in some contexts.

Additionally, the present inventor has also found that while thickness of 5 mils or greater can work in various implementations, the increased thickness to 5 mils or beyond in thickness can potentially lead to increased difficulty to cut the material to be formed into expandable slit sheet material. Thus, in some embodiments, thicknesses of the intermediary material layer IM may be limited to avoid inhibiting of the cutting capability of the device.

The present inventor has observed that prior systems for fabricating expandable slit sheet material, which did not employ an intermediary material layer IM as per embodiments of the present invention faced considerable forces and pressures. For example, the present inventor observed that pressures far greater than 3,000 psi were often present, and observed that previously pressures had risen to about 4,000 psi, leading to failures of machinery, including, e.g., breakage of a shaft in one example. With the preferred embodiments employing an intermediary material layer IM, the present inventor has been able to drastically reduce pressures to well below 1,000 psi, and even down to 600 psi and below in some embodiments. Thus, the present inventor has been able to reduce the pressure forces involved by factors of up to less than ½, or, in some examples, less than ⅓, or, in some examples, less than ¼ of the pressures involved in prior systems without an intermediary material layer.

For example, the present inventor discovered that with a prior example in which a shaft broke with pressures up to 4,000 psi, by upgrading the system to include an intermediary material layer according to embodiments of the present invention, pressures dropped to about 1000 psi or below, and the system achieved substantially better and cleaner cuts in the expandable slit sheet paper. The present inventor further discovered that pressures could be reduced to even 600 psi or below employing embodiments of the present invention, and found that pressures at or near zero could even be achieved with the employment of intermediary material laminate layers having a thickness of greater than about 1 mil, such as, e.g., about 1.5 or 2 mil or greater than 2 mil.

Slitting operation without laminated was produced by crushing paper between blades and anvil. When laminate is used formation of slits is achieved by blade puncturing the paper and passing through the paper to the laminate thereby cutting the paper to form slits, rather than crushing.

Advantages of Slit Cutting of Present Invention Over Prior Crush-Cutting of Expandable Slit Sheet Paper

For decades, expandable slit sheet paper has been formed by crush cutting of paper to form arrays of slits in the paper to create expandable slit sheet paper. This has been uniformly and standardly performed in the industry for decades. Towards this end, existing crush cut systems have employed rotary blades that are pressed against a smooth and solid metal anvil to cut slits within the paper sheets to form expandable slit sheet paper. Although this existing methodology has proven to be acceptable within the industry, the present inventor has discovered that—in the context of creating expandable slit sheet paper sheets—such crush cutting methodologies actually have underlying problems that lead to complications in the fabrication process as well as resulting in inferior expandable slit sheet paper products.

For example, as described above, in order to effect crush-cutting, substantial forces must be applied between knives or blades of a rotary die and a hard peripheral surface of an anvil. Additionally, in order to effect crush-cutting, the dimensions and tolerances of the system must be strictly maintained. Additionally, in order to effect crush-cutting, the knives or blades must be strong and maintain consistency and shape to ensure consistency of cutting. Additionally, in order to effect crush-cutting, the surface of the anvil required consistent and smooth surface configuration.

The present inventor discovered that although prior expandable slit sheet paper products worked—that is, although, the prior slit sheet paper products were able to be expanded and utilized as expandable slit sheet paper—the present inventor discovered that prior slit sheet paper had some drawbacks. For example, the present inventor discovered that crush-cutting invariably lead to some paper fibers remaining that connect across the width of the cuts. Although such connecting fibers may not preclude the slits from opening (i.e., such fibers being stretched, torn or the like upon expansion to enable opening of the cells of the expandable slit sheet paper), the present inventor discovered that such connecting fibers had other drawbacks. For example, such connecting fibers lead to: a) expandable slit sheet papers requiring greater forces to effect expansion; b) expandable slit sheet papers having greater retractive forces that tend to cause the paper to seek to elastically return to an unexpanded state (e.g., leading to a need to strengthen some products, such as, e.g., envelopes in some examples to enable the products to contain expandable slit sheet paper in an expanded state without the retractive forces of the expandable slit sheet paper impacting the operation of the product); c) expandable slit sheet papers previously could not be formed with very small slit lengths as the expandable slit sheet paper would have difficulty in expansion to form open cells when slit length is too small (e.g., due to numerous connecting fibers inhibiting expansion); d) etc.

Additionally, the present inventor also discovered that crush-cutting of expandable slit sheet paper not only leads to random fibers remaining uncut (e.g., which can inhibit expansion or the like as discussed above), but also that such crush-cutting can lead to irregularities in the consistency of cell-opening. For example, the present inventor even previously developed mechanisms to alter the manner of expansion (such as to, e.g., create an alternating expansion patter) by adapting the manner of crush-cutting to vary the manner of opening of the expandable slit sheet paper. See, e.g., the present inventor's prior U.S. Pat. No. 10,226,907, incorporated herein by reference above. Thus, the present inventor has discovered that by implementation of the preferred embodiments of the invention described herein, an expandable slit sheet paper can be created that has a more consistent expansion pattern, without or with significantly reduced switch back in the expansion pattern that had previously resulted with prior crush-cut methodologies.

Additionally, the present inventor also discovered that the present invention, employing an intermediary material layer IM can dramatically reduce wear and tear on the machinery of the device, such as, e.g., greatly reducing wearing of gears, wearing of blades, anvil and other components.

Additionally, the present inventor also discovered that an intermediary material layer IM can be very inexpensive and cost-effective and quick and easy to replace, greatly reducing the operation costs, delays and other problems associated with prior systems. For example, replacement of worn-out blades and/or dies is time consuming and expensive. In contrast, replacement of an intermediary material layer (such as, e.g., a polyester laminate applied to wrap around an anvil) is minimal in comparison to the removal and replacement of worn-out blades, dies and/or anvils. Removal and replacement of the intermediary material layers or laminates, as needed, is, on the other hand, fast and easy and comes with a de-minimis material cost. Additionally, labor cost is also dramatically reduced due to ease of replace of laminate verses the difficulty of replacement of blades, gears, anvils, etc.

Additionally, the present inventor also discovered that by implementing embodiments of the present invention to create expandable slit sheet paper products, a highly improved expandable slit sheet product could be achieved, which further enabled the creation of expandable slit sheet papers having capabilities and applications not possible with background technologies. As some examples, the present inventor discovered that some or all of the following novel expandable slit sheet paper products can now be achieved with the present invention:
A) An expandable slit sheet paper can be created that has advantageous utility in the creation of pallet wrapping expandable slit sheet paper products. First, the present inventor discovered that slit sizes can be greatly reduced, helping to lead to expandable slit sheet paper products useful for pallet wrapping (e.g., with sufficient tensile strengths). Second, the present inventor discovered that the cleanness of the slitting helps lead to cleaner opening of the slits, including less tearing of the slits (e.g., due to the lack of connecting fibers, etc.), which further increases the tensile strengths of the expandable slit sheet paper product. As discussed herein, the present inventor has discovered that the present technology can be used to create embodiments like that of the various pallet wraps described in the above-listed patents of the present inventor that are incorporated herein by reference. Additionally, the present inventor has discovered that the present technology can be used to create embodiments like that of the various pallet wraps described in the above-listed patents of the present inventor that are incorporated herein by reference even without the use of extensible paper. Additionally, the present inventor has also discovered that the present technology can be used to create embodiments like that of the various pallet wraps described in the above-listed patents of the present inventor that are incorporated herein by reference along with the use of extensible paper in a manner to provide a vastly superior product with advantages of both the present invention and the use of extensible paper (as discussed in the patents incorporated herein by reference).
B) An expandable slit sheet paper can be created that has advantageous utility in the creation of envelopes and mailer expandable slit sheet paper products. First, the present inventor discovered that slit sizes can be greatly reduced, helping to lead to expandable slit sheet paper products useful for envelopes and the like (e.g., helping achieve desirable cushioning and minimum dimensions). Second, the present inventor discovered that the cleanness of the slitting helps lead to cleaner opening of the slits, with less connective fibers that may otherwise lead to retractive forces having a tendency to bend or wrinkle envelopes or mailers. As discussed herein, the present inventor has discovered that the present technology can be used to create embodiments like that of the various envelope products described in the above-listed patents of the present inventor that are incorporated herein by reference. Additionally, the present inventor has discovered that the present technology can be used to create embodiments like that of the various envelopes described in the above-listed patents of the present inventor that are incorporated herein by reference even without the use of extensible paper. Additionally, the present inventor has also discovered that the present technology can be used to create embodiments like that of the various envelopes described in the above-listed patents of the present inventor that are incorporated herein by reference along with the use of extensible paper in a manner to provide a vastly superior product with advantages of both the present invention and the use of extensible paper (as discussed in the patents incorporated herein by reference).
C) An expandable slit sheet paper can be created that has advantageous utility in the creation of void-fill products. As discussed herein, the present inventor has discovered that the present technology can be used to create embodiments like that of the various void-fill products described in the above-listed patents of the present inventor that are incorporated herein by reference. Additionally, the present inventor has discovered that the present technology can be used to create embodiments like that of the various void-fill described in the above-listed patents of the present inventor that are incorporated herein by reference even without the use of extensible paper. Additionally, the present inventor has also discovered that the present technology can be used to create embodiments like that of the various void-fill products described in the above-listed patents of the present inventor that are incorporated herein by reference along with the use of extensible paper in a manner to provide a vastly superior product with advantages of both the present invention and the use of extensible paper (as discussed in the patents incorporated herein by reference).

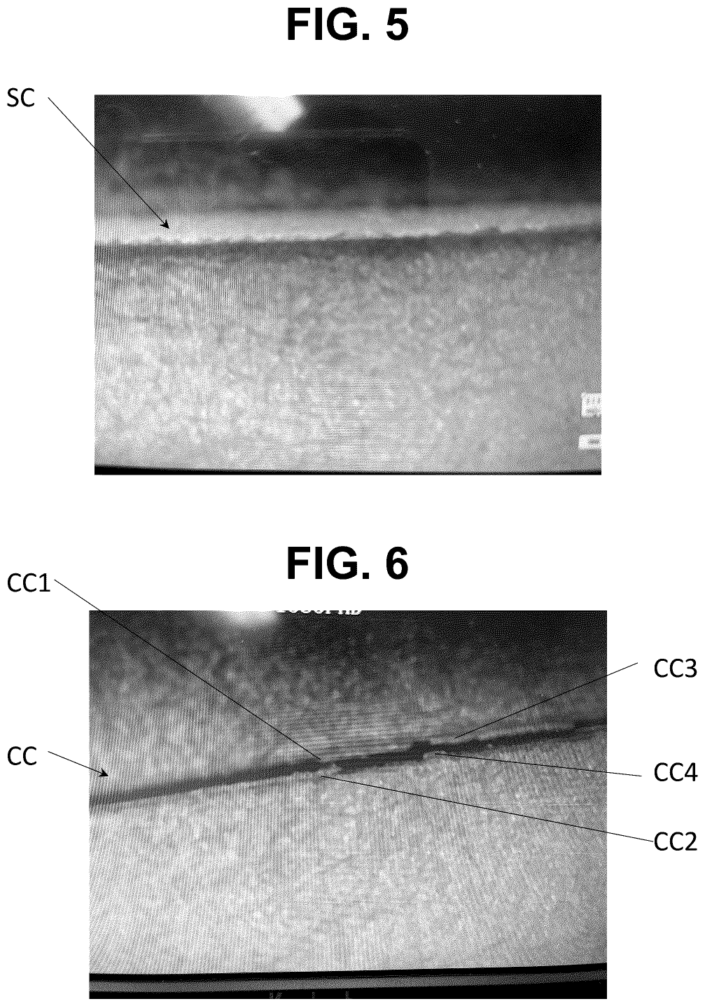

To facilitate reference, FIG. 5 shows an enlarged image of an example of the present invention in which a slit cut SC is formed within a sheet of paper to form an expandable slit sheet material in accordance with an embodiment of the present invention, employing an intermediary material layer IM as described herein. As shown, the slit formed in this manner has a substantially clean edge, with no fiber extensions or connections across within and/or across the width of the slit.

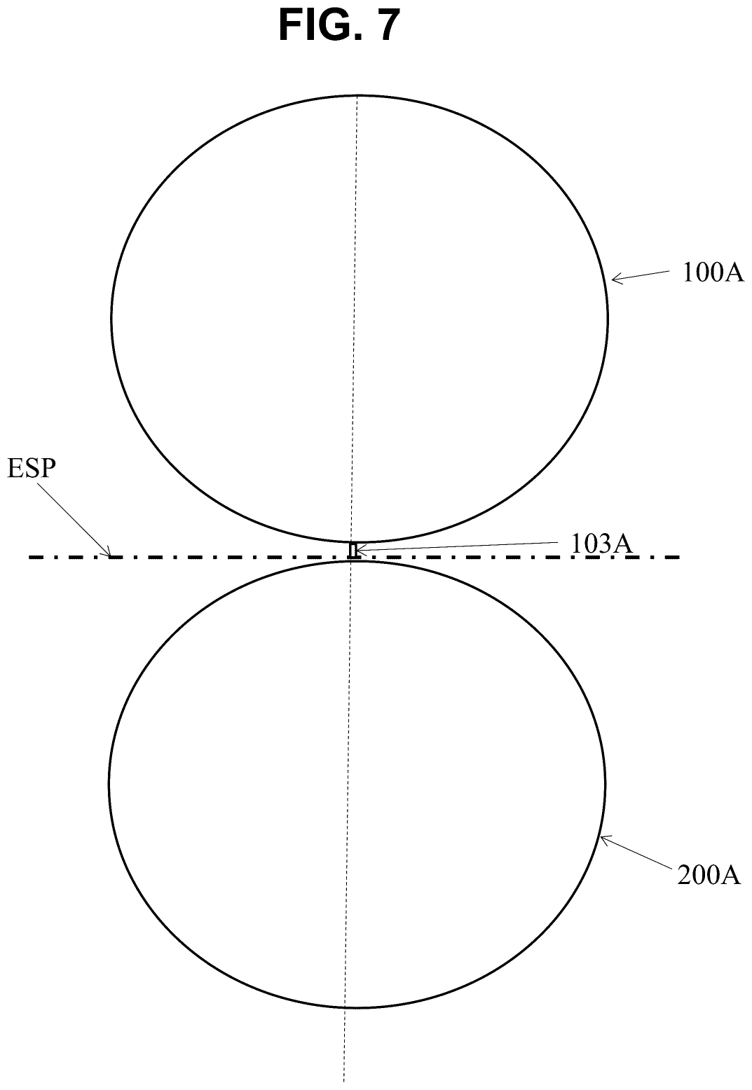

In contrast, FIG. 6 shows an enlarged image of an example of a crush cut slit CC formed in accordance with the background art, in which the slit CC is formed by a knife that is employed to cut the paper by pressure force against a rigid surface of an anvil. As shown in the figure, such a prior formed slit CC results in fibers and/or sections that extend across within and/or across the width of the slit. See, e.g., fibrous elements CC1, CC3 extending off of one side of the slit, and fibrous elements CC2, CC4 extending off of the opposite side of the slit. Notably, the elements CC1 and CC2 are initially connected together via at least some connected fibers and the elements CC3 and CC4 are initially connected together via at least some connected fibers even after crush cutting to form the slits, and the elements CC1 and CC2 are separated upon pulling the paper to open the slits and the elements CC3 and CC4 are separated upon pulling the paper to open the slits.

Although difference between forming slits by crush cutting and by slit cutting in accordance with embodiments of the present invention can be identified by microscopic images of exemplary cuts so as to reveal the substantial difference in the quality and features of slits, this resulting difference is difficult to avoid because expandable slit sheet materials are typically formed with paper having numerous fine filaments and fibers, and any minor variation in tolerances or surface shapes, etc., would certainly lead to inconsistencies of such crush cuts.

As discussed above, the present inventor also discovered that when expandable slit paper is formed by cutting slits in accordance with embodiments of the present invention, the expandable slit sheet paper has a substantially lower resistance to opening than expandable slit sheet paper that has slits produced by crush cutting. Notably, opening of expandable slit sheet paper having crush cut slits also comes with other problems and issues—for example, due to connective fibers (as discussed above), expansion of the expandable slit sheet paper that has been crush-cut also leads to increased noise (e.g., crackling, etc.) and increased dust and particulates (e.g., caused in the crushing process, as well as in the separation process).

As also discussed above, with prior crush-cutting systems and methods, in order to cut slits into paper or the like materials, a substantial amount of force is required. As a result, the machinery and components can be readily damaged. Additionally, the machinery and components must also be configured to withstand greater forces. By way of example, the blades or knives of prior systems required greater strength and rigidity and, thus, were not able to be formed as thin or as sharp to create the most advantageous and desirable cutting of the expandable slit sheet paper. Additionally, because prior systems and devices required a pressure contact between the surface of the anvil and the ends of the blades, as surfaces of the anvil chipped or otherwise deformed and as the blades wear down, chip, bend or otherwise deformed, the quality of the slits formed were adversely affected.

Conversion of Crush-Cutting Devices to Slit-Cutting Devices

As discussed above, in some preferred embodiments, existing systems and devices for forming expandable slit sheet materials such as, e.g., expandable slit sheet paper, can be readily converted to devices according to the present invention very quickly, easily and inexpensively.

In some preferred embodiments, an existing crush-cutting device can be quickly converted to a slit-cutting device according to an embodiment of the present invention by simply applying an intermediary material layer IM around an anvil, without modification of the knives, the anvil and/or other components. In some preferred embodiments, the intermediary material layer IM can be formed between about 1 mil (i.e., 0.001 inch) and about 5 mil, and, in some other preferred embodiments, the layer can be formed between about 2 mil and 4 mil. In some embodiments, the layer IM can be formed from a single sheet that is wrapped once around the anvil. In some embodiments, the layer IM can be formed from a single sheet that is wrapped plural times around the anvil. As discussed above, in the preferred embodiments, when the layer IM is wrapped around the anvil, it is preferably adhered to the anvil employing a mild adhesive. In some embodiments, the layer IM can be similar to a piece of tape; similarly, in some embodiments, the layer IM can even be initially provided on a roll similarly to a tape dispenser roll, and the layer IM can be removed from such a roll with the adhesive along one side of the layer IM similarly to a piece of tape dispensed from a tape dispenser.

In the preferred embodiments, when the layer IM is applied to the anvil, air bubbles, folds and the like are, preferably, avoided to provide the layer IM with a substantially consistent thickness. However, the present inventor has also discovered that some inconsistencies of the layer IM due to air bubbles, wrinkles, overlapping of edges of the layer do not appreciably affect operation and quality in many instances. For example, if 3 layers of 1 mil polyester film is wrapped around the anvil, but an end overlaps further such as to create a region that is about 4 mil (i.e., due to a narrow overlap section having 4 layers due to the overlap), the device can function desirably because the appropriate thickness of the intermediary material layer IM can be within a desired range of thicknesses. Accordingly, the use of the intermediary material layer IM also helps to facilitate installation and usage because there is a wider range of tolerance with the installation of the intermediary material layer.

In some illustrative embodiments, when an intermediary material layer IM is desired to be removed and replaced, a user can simply unwind the intermediary material layer IM from the anvil similarly to unwinding a piece of tape from a roll of tape. Then, the user can wind a new layer IM or a plurality of new layers to form the intermediary material layer IM around the anvil. In some embodiments, due to the range of thicknesses acceptable of the intermediary material layer IM, even if some small pieces of the original layer remains and/or adhesive remains on the anvil, a new intermediary material layer IM can be applied even over some existing adhesive and/or intermediary material. In this manner, replacement of intermediary material layer can be very easy and quick in many implementations. In some other embodiments, if desired, the removal of the intermediary material layer IM and the adhesive can be done with scraping elements and/or chemical cleaners to help remove the intermediary material layer, such as, e.g., removing the original intermediary material layer IM laminate and adhesive using a metal (e.g., brass) scraper and a degreaser.

### Discussion of the Embodiments Shown in the Figures

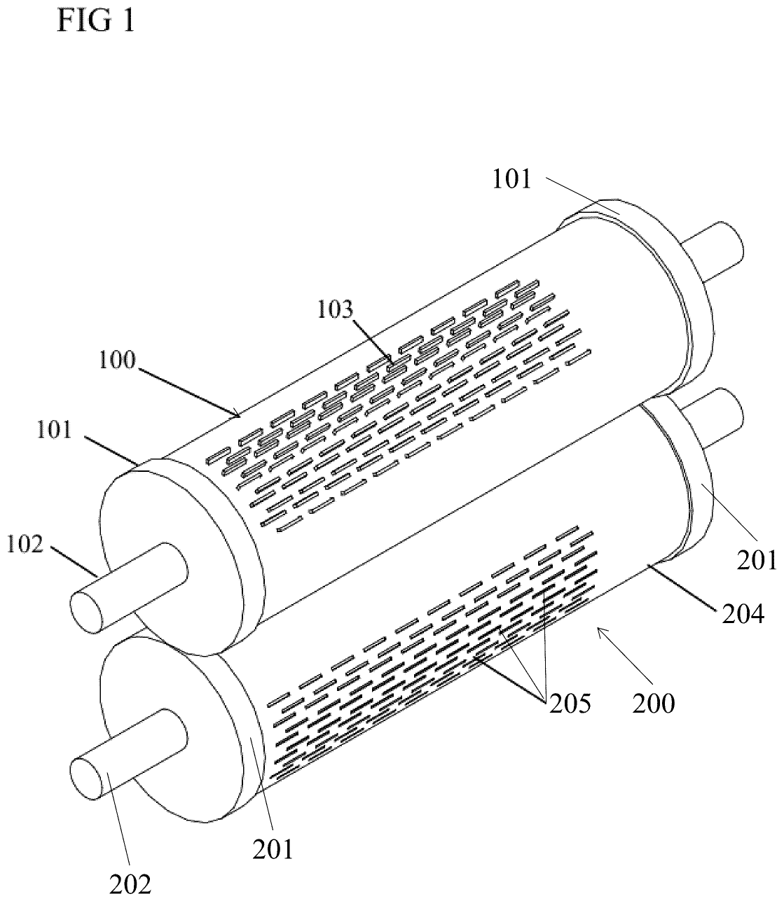

With reference to FIG. 1, FIG. 1 shows an illustrative embodiment of the present invention. In particular, FIG. 1 shows an illustrative rotary die member 100 having an array of knives or blades 103 extending around the perimeter circumference thereof (note: although blades 103 are shown as over a portion of the perimeter circumference of the member 100, in the preferred embodiments, the array of blades 103 extends around the entire perimeter circumference of the die member 100). As shown, the rotary die member 100, includes a central shaft 102 for imparting rotational movement to the rotary die member 100 (e.g., via gears, drive motor, controller, etc.). As also shown, the rotary die member 100 also includes two bearer members 101 at the ends of the rotary die member. The bearer members 101 are arranged to press and roll against the respective bearer members 201 of the anvil 200 as described herein-above.

As shown in FIG. 1, the anvil 200 includes an intermediary material layer 204 around the perimeter circumference thereof. As shown, the outer surface of the layer 204 is recessed slightly below the outer surface of the bearer members 201 such that the forces between the rotary die member 100 and the anvil 200 are mainly distributed through the bearer members 101 and 201.

As shown in FIG. 1, the intermediary material layer 204 is formed to include recesses or grooves 205 corresponding to the blades 103 by pressing of the die member 100 against the anvil 200 (e.g., via the bearer members 101, 201) and rotating the die member and anvil 200 relative to one another such that the blades 103 extend into the intermediary material layer 204 and create such recesses or grooves 205 around the periphery of the anvil. Although recesses or grooves are depicted only around a portion of the periphery of the anvil, it should be appreciated that the entire periphery of the anvil would be adapted to include such recesses or grooves corresponding to the locations of the respective blades 103 of the die member 100.

In the illustrative embodiment shown in FIG. 1, the diameter of the die member 100 is set to be equal to the diameter of the anvil 200, such that each blade 103 will correspond to a respective recess or groove 205 formed therefrom in the anvil—i.e., such that after a full rotation, the same blade 103 will be received within the same recess or groove 205 originally created by that same blade 103. Among other things, this one-to-one relationship of the blades 103 and the recesses or grooves 205 can also help lead to the creation of fine tolerances and quality because, among other things, the recesses or grooves will be finely adapted to the shape or orientation of each respective blade 103. Similarly, in the event that any of the blades may shift or bend, the intermediary material layer 204 can simply be removed and replaced with a new layer 204 such as to “re-set” the relationship between the blades and the recesses or grooves 205.

Although not shown in FIG. 1, in some preferred embodiments, the anvil 200 is similarly caused to rotate via gearing and a driving mechanism (e.g., drive motor) that imparts rotation to the anvil 200 via the shaft 202.

In some embodiments, the die member 100 and the anvil 200 are adapted from an existing system that includes the anvil 200 without an intermediary material layer 204, wherein the blades 103 are provided and arranged such as to crush cut a paper material to create an expandable slit sheet material by crush cutting the paper material between ends of the blades 103 and a smooth outer peripheral surface of the anvil (e.g., a smooth metal perimeter of the anvil). In some such embodiments, the anvil 200 is adapted by applying a peripheral layer forming the intermediary material layer 204 that surrounds the anvil, such as to adapt the device from a prior crush-cutting system to a slit-cutting system in which the tips of the blades 103 are configured to pass entirely or substantially entirely through the paper material being slit by the system.

For reference, FIG. 200 is a diagram showing the system of FIG. 1 with an intermediary material layer IM being applied around the perimeter of the anvil 200. As shown, the intermediary material layer IM is preferably sized such as to have a width (i.e., in a direction parallel to the center axes of the die member 100 and the anvil 200) that fits entirely or substantially entirely across the length of the anvil between the bearer members 201 at the respective ends thereof, and the intermediary material layer also preferably has a length that is equal or approximately equal to length of the circumference of the anvil such as to entirely surround the anvil when applied thereto (as discussed above, in some embodiments, the intermediary material layer IM can be applied to the anvil using adhesives or the like).

As described herein, in various embodiments, the intermediary material layer IM can be made with a variety of materials, and can be formed such as to have a variety of depths (e.g., thicknesses). In some illustrative and non-limiting embodiments, the intermediary material IM layer is made with an elastomeric or plastic material that is soft respectively to the blades such that the blades cause the elastomeric or plastic material to flow, cut or deform such that the blades penetrate the intermediary material layer IM, as discussed above. In some preferred embodiments, the intermediary material layer is formed with a thermoset material. In some preferred embodiments, the intermediary material layer IM is formed with a polyester material.

In some illustrative an non-limiting examples, the intermediary material layer IM is formed to have a thickness of between about 0.25 and 10 mil, while, in some embodiments, the intermediary material layer is formed to have a thickness of between about 0.75 and 8 mil, while, in some embodiments, the intermediary material layer is formed to have a thickness of between about 1.5 and 6 mil, while, in some embodiments, the intermediary material layer is formed to have a thickness of between about 2.0 and 5 mil.

In the preferred embodiments, the tips of the blades are arranged such as to not touch the periphery of the anvil 200 after penetrating into the intermediary material layer, and also such as to not crush the paper material between the end of the blades 103 and the periphery of the anvil 200. Thus, due to the softer nature of the intermediary material layer, the forces between the blades and the anvil can be maintained very low in comparison with prior systems.

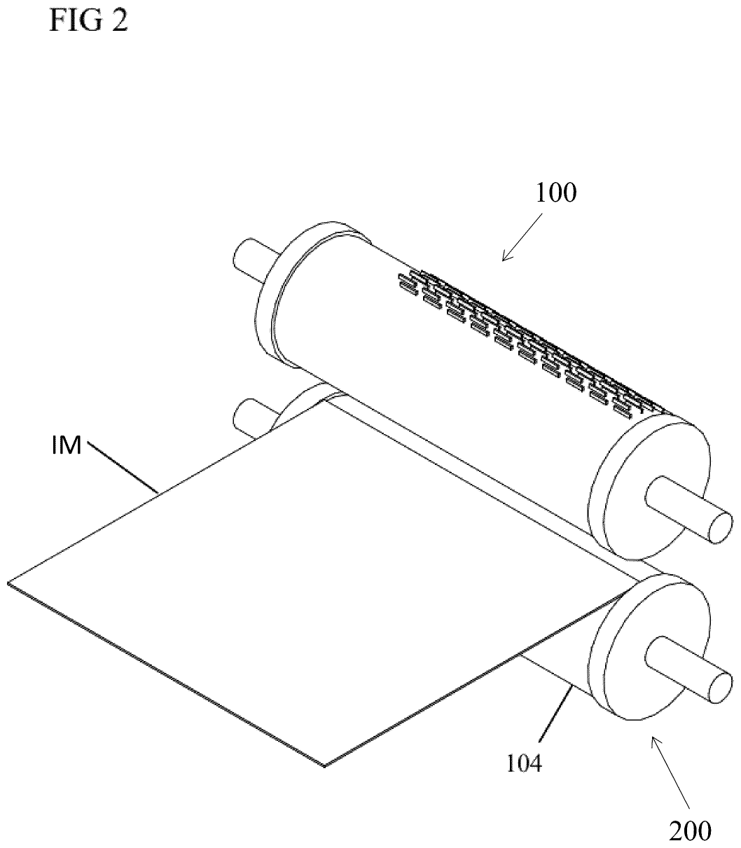

With reference to FIG. 3, FIG. 3 shows an illustrative image of an exemplary intermediary material layer IM that can be employed in some embodiments of the present invention. Towards that end, FIG. 3 shows an illustrative roll of polyester film that can be employed in some embodiments. As illustrated in FIG. 3, the intermediary material layer IM is preferably relatively soft (e.g., such that it can be freely wound around a roll and also wound around an anvil as shown in FIGS. 1 and 2), and such that it can be freely manually manipulated by a user as shown in FIG. 3. In some non-limiting examples, the intermediary material layer IM shown in FIG. 3 is the above-described clear general purpose polyester film of Qspac Industries, Inc., product number 916C employed in some illustrative experimental implementations.

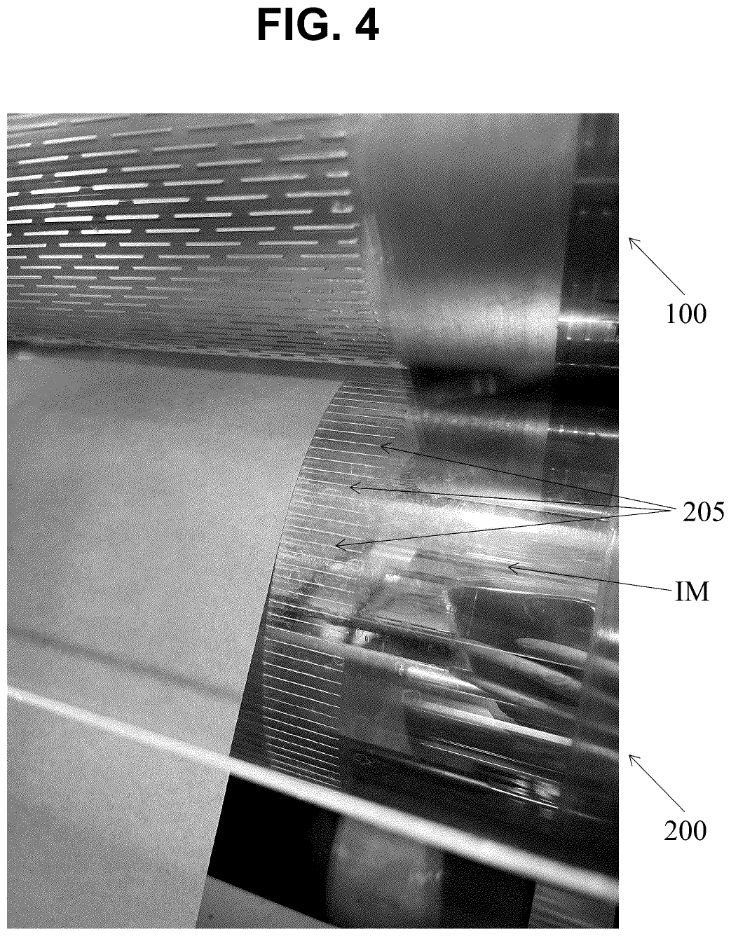

With reference to FIG. 4, FIG. 4 shows an illustrative image of the exemplary intermediary material layer shown in FIG. 3 wrapped around an anvil 200 in accordance with an illustrative embodiment of the invention. In the image shown in FIG. 4, the die member 100 has already rotated in relation to the anvil 200 such as to cause an array of recesses or grooves 205 as shown.

In the illustrative embodiment shown in FIG. 4, the respective diameters of the die member 100 and the anvil 200 are different from one another. Specifically, in this illustrative and non-limiting example, the diameter of the roller of the die member 100 roller is larger than the roller of the anvil 200. In this illustrative embodiment, although the rollers are not the same size (i.e., do not have the same size diameters), the relative sizes of the rollers is selected such as to have a consistent pitch or relationship. Specifically, the relative sizes are preferably selected such that upon each rotation, the blades of the die member do not re-align with the same recess or groove, but shift to align with another recess or groove upon a complete rotation of the die member 100. In this manner, the blades will not consistently impinge upon the same location along the anvil.

In the illustrative embodiment, the pitch between rows of blades is ⅛ inch. In the illustrated example shown in FIG. 4, the rollers of the die member 100 and the anvil 200 are not the same size, but have the same gear pitch of ⅛″ which, is the same distance as the distance between the blade rows (NB: it should be understood that this pitch can be adapted as desired based on configurations of the expandable slit sheet material being formed, such as, e.g., the desired slit sizes and slit spaces being implemented). In the embodiment shown in FIG. 4, the recesses or grooves 205, thus, formed within the intermediary material layer IM extend continuously across the lengthwise direction of the anvil (i.e., due to being formed by adjacent rows of blades that are offset from one another, due to the different diameters causing adjacent rows of blades to impinge upon different recesses or grooves upon each rotation of the die member 100). For example, a first knife row will initially contact the intermediary material layer IM at a first slot row, and after a full rotation of the die member 100 will then enter a second slot row in a manner to eliminate the segmented cutting and form structure in which the slots (i.e., recesses or grooves) extend continuously across the lengthwise direction of the anvil as shown in FIG. 4.

The present inventor has discovered that in some implementations, a prior crush-cutting system can be greatly improved by the inclusion of an intermediary material layer IM of the preferred embodiments of the present invention, such as to adapt the device to create slit cutting in accordance with embodiments of the present invention, rather than prior crush cutting.

The present inventor has discovered that prior systems that involved substantial pressures between die members and anvils can be greatly improved and that pressures could be greatly reduced. For example, the present inventor discovered that prior systems that involved pressures of between about 2,500 to 4,000 psi could be readily reduced by more than 20%, or, could be readily reduced by more than 30%, or, could even be readily reduced by more than 40%, or, could even be readily reduced by more than 50%, or, could be readily reduced by more than 60%, or, could even be readily reduced by more than 80%, or, could even be readily reduced by more than 100%, or, could even be readily reduced by more than 150%, or, could even be readily reduced by more than 200%, or, could even be readily reduced by more than 300%, or, could even be readily reduced by more than 400%, or, could even be readily reduced by more than 500%, or, could even be readily reduced by more than 600%, or, could even be reduced by more than 700%, or, could even be reduced by more than 800%, or, could even be readily reduced by more than 1000%.

By way of example, the present inventor found that a prior system that crush-cut at 3000 psi could be readily adapted to cut at 600 psi or even below by upgrading the prior system to include an intermediary material layer IM according to an embodiment of the present invention.

By way of another example, the present inventor found that a prior system that crush-cut at 1200 psi could be readily adapted to cut at 500 psi or even below by upgrading the prior system to include an intermediary material layer IM according to an embodiment of the present invention.

By way of another example, the present inventor found that a prior system that crush-cut for the creation of an expandable slit sheet paper pallet wrap at 2500 psi could be readily adapted to cut at 1500 psi or even below by upgrading the prior system to include an intermediary material layer IM according to an embodiment of the present invention.

The present inventor discovered that my upgrading prior systems to include an intermediary material layer IM in accordance with embodiments of the present invention, a consistently superior expandable slit sheet material product can be achieved (e.g., due to highly superior and cleaner cuts formed within the product) at substantially reduced pressures.

The present inventor also discovered that by adjusting the thickness of the intermediary material layer (i.e., according to circumstances), the quality of the cuts made within the expandable slit sheet material product can be significantly enhanced and the pressures can be significantly reduced (e.g., even substantially to or near 0 psi).

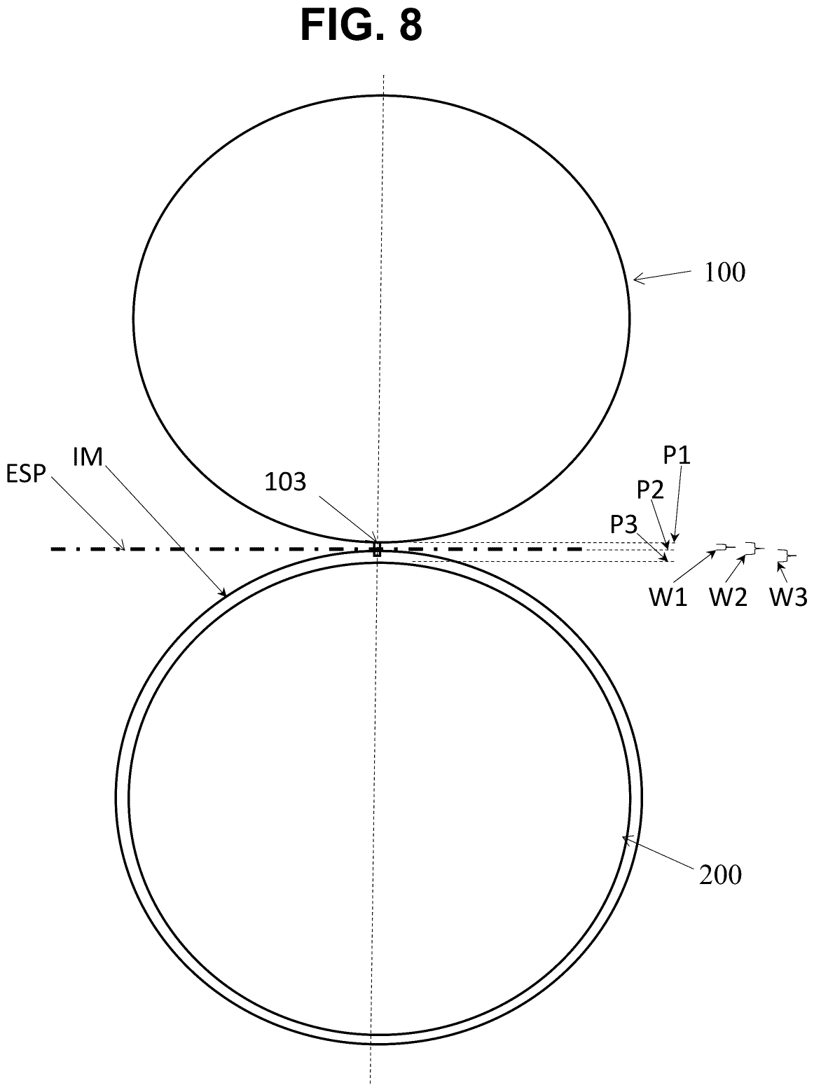

With respect to FIG. 7, FIG. 7 is a schematic diagram showing a die member 100A according to a background crush-cutting system in which a plurality of blades 103A are distributed around the periphery of the die member 100A, and the blades are arranged to crush cut slits into a paper sheet ESP to form an expandable slit sheet paper. As schematically shown in FIG. 7, the distal end of the blade 103A is arranged to press a top surface of the paper sheet ESP against a hard (i.e., a rigid metal outer surface) of the anvil 200A.

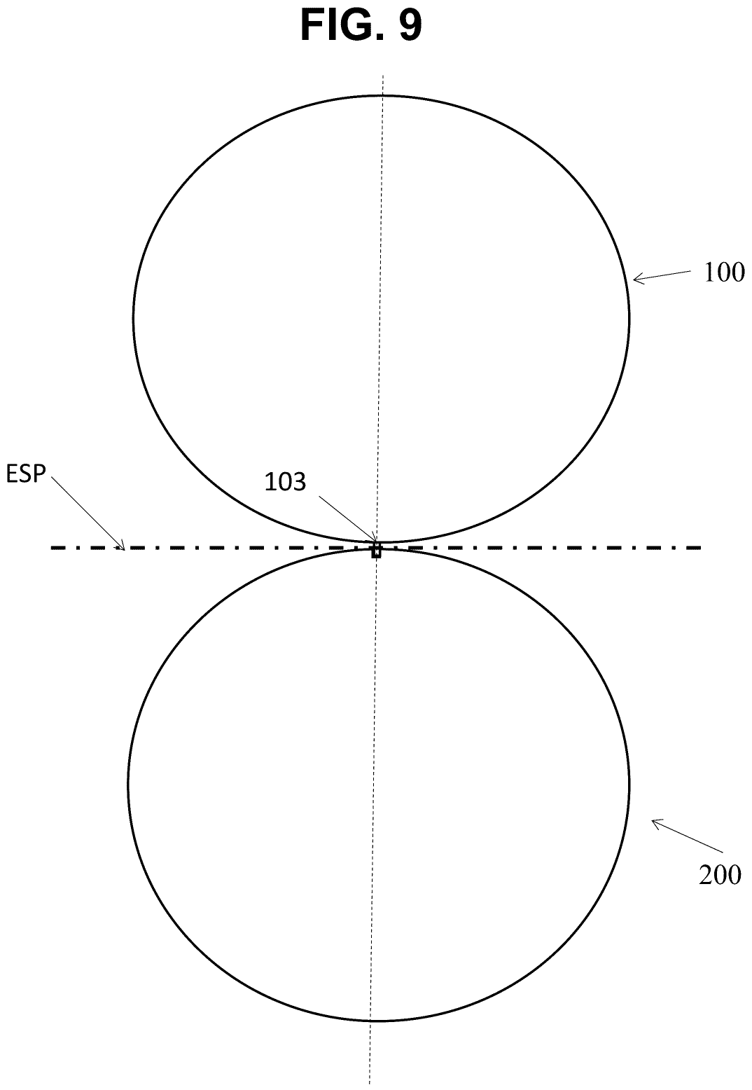

With respect to FIG. 8, FIG. 8 is a schematic diagram showing an upgrading system according to an illustrative embodiment of the invention in which a system similar to that shown in FIG. 7 is adapted to include an intermediary material layer IM in accordance with some embodiments of the present invention.

As shown in FIG. 8, the system is adapted for slit cutting with a plurality of blades 103 distributed around the periphery of the die member 100, and the blades are arranged to slit cut slits into a paper sheet ESP to form an expandable slit sheet paper. As schematically shown in FIG. 8, the distal end of the blade 103 is arranged to penetrate and pass through the paper sheet ESP and into the intermediate material layer IM without pressing the paper sheet ESP against a hard surface of the anvil 200.

As schematically shown in FIG. 8, the lower surface of the roller of the die member 100 is located at the position P1, the upper surface of the intermediary material layer IM is located at the position P2, and the upper surface of the outer peripheral surface of the anvil below the intermediary material layer IM is located at the position P3. As also schematically shown in FIG. 8, the distance between the position P1 and the position P2 is represented by the width W1; the width W1 also being a width that accommodates the width of the paper sheet ESP which is slit with the system shown in FIG. 8. As also schematically shown in FIG. 8, the length of the blade 103 is also shown as the length W2. Notably, as shown, the length W2 is preferably less than the distance between points P1 and P3, such that the blade 103 does not contact or apply pressure directly against the outer surface of the anvil under the intermediary material layer IM. As also schematically shown in FIG. 8, the width W3 represents the thickness of the intermediary material layer IM. As shown in FIG. 8, the thickness of the width W3 is preferably selected such that the outer surface of the intermediary material layer IM at position P2 can contact and support the paper sheet ESP, while the blade 103 extends entirely through the paper sheet ESP, such as to slit-cut the paper sheet, an extends a distance within the intermediary material layer IM, without contacting the outer surface of the anvil under the intermediary material layer IM as discussed above.

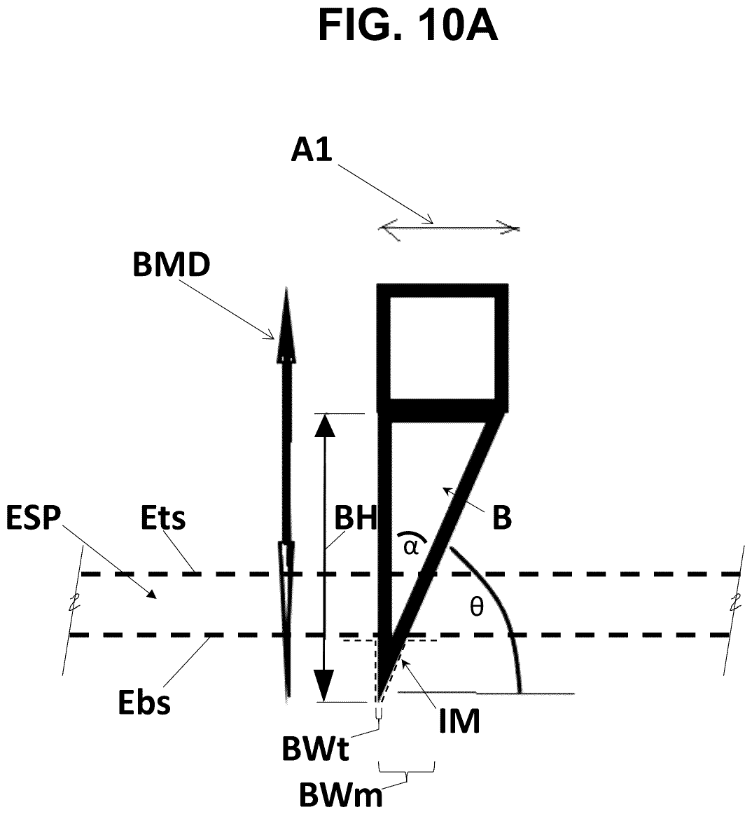

With respect to FIG. 9, FIG. 9 is schematic diagram of another illustrative embodiment in which the anvil 200 is formed such that the outer peripheral surface is a non-rigid material, similar to the qualities of the intermediary material layer IM shown in FIG. 8. Thus, as shown in FIG. 9, the blade 103 penetrates into the anvil 200 as shown. The use and operation of the embodiment shown in FIG. 9 is parallel to that shown in FIG. 8, except that the anvil 200 in FIG. 9 does not have a separate intermediary material layer that is applied therearound. In some embodiments, the entire anvil 200 can include such a softer or non-rigid material, or, the material of the anvil 200 can be otherwise adapted to be softer proximate a periphery thereof, or, anvil 200 can be substantially made with a softer or non-rigid material and can include a hard or rigid central support shaft or other member(s) for rigidity.

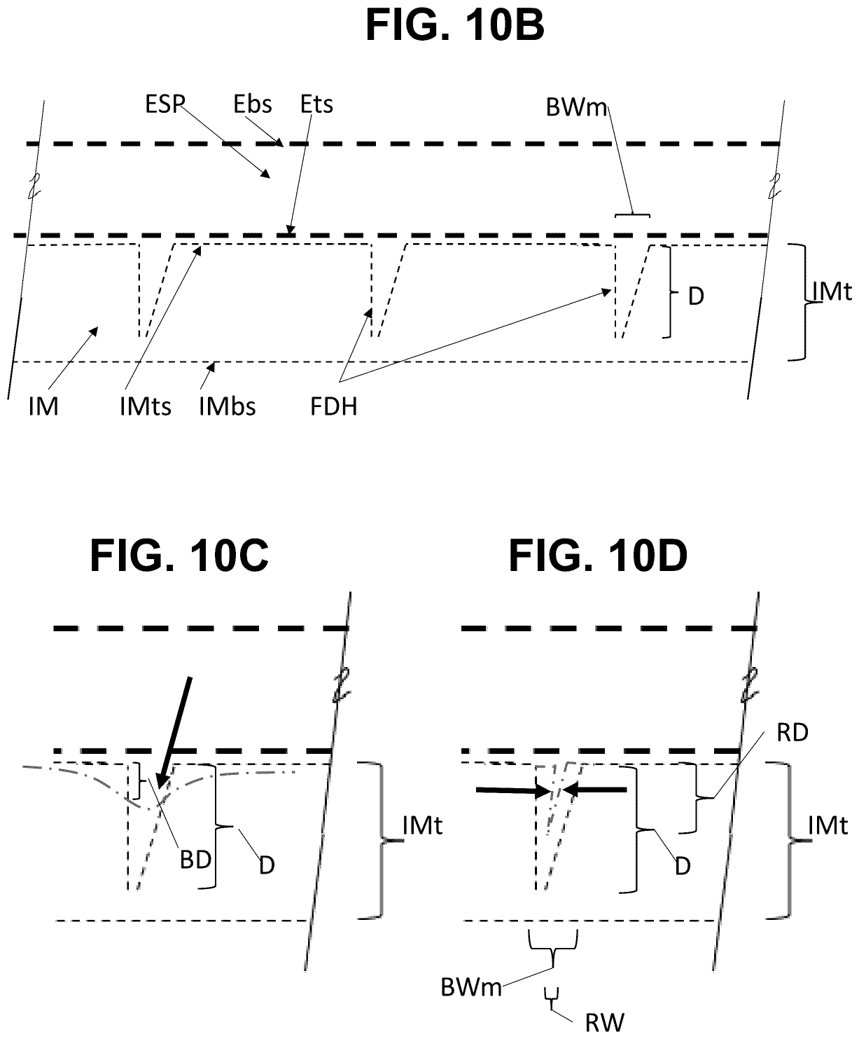

With respect to FIG. 10A, FIG. 10A is a schematic diagram showing a region of the knife blade 103, similar to that of the region of the knife blade 103 shown in, e.g., FIG. 8. As shown in FIG. 10A, a knife blade B (e.g., which is, in some preferred embodiments, one illustrative blade among an array of blades distributed around a rotary die member as described herein-above) is provided. As also shown in FIG. 10A, the knife blade B preferably has a length BH that is long enough to extend through the paper sheet ESP and also to extend into and penetrate the intermediary material layer IM (see dashed lines representing an upper surface of the intermediary material layer IM penetrated by the blade B). As also shown in FIG. 10A, the knife blade is caused to penetrate the paper sheet ESP and the intermediary material layer IM by relative displacement of the knife blade relative to the intermediary material layer IM along a direction of the arrows BMD shown in FIG. 10A (e.g., towards and/or away from one another). Towards this end, in embodiments in which the die member and anvil are rotary members, such as, e.g., shown in FIGS. 8, etc., the relative movement along the direction of the arrows BMD is affected by relative rotation of the die member and the anvil member. However, in alternative embodiments in which the die member and the anvil member are not rotated relatively to one another, the relative movement along the direction of the arrows BMD can be affected by employing a mechanism that relatively reciprocates the blades B with respect to the intermediary material layer IM.

With reference to FIG. 10A, it can be seen that with preferred embodiments of the present invention, the blade B can extend or penetrate entirely through the width of the paper sheet ESP (i.e., extending through from the upper surface Ets to and through the bottom surface Ebs of the paper sheet ESP).

With reference to FIG. 10A, with embodiments of the present invention, as discussed herein-above, the blade B can be configured for enhanced cutting capabilities with reduced strength and rigidity concerns as compared to prior systems that employed crush-cutting that required substantial forces upon the blades. As a result, in some embodiments of the invention, the blades B, 103, or the like, can be adapted for enhanced cutting and slitting. For example, in some embodiments, the tip or distal ends of the blades B can be much sharper because such ends will not impinge against a hard or rigid surface and/or will not be required to apply a crushing pressure opposite to such a hard or rigid surface; thus, the width BWt of the tip end of the blades B can be substantially reduced. As another example, in some embodiments, the width of the blades at positions above the tip ends of the blades can also be reduced; thus, for example, the width of the blades BWm proximate a mid-region of the blades B corresponding to the level of the top surface of the paper sheet Ets when the blade penetrates the paper sheet ESP as shown in FIG. 10A can be substantially reduced. In this manner, the blade can achieve a cleaner and better cut into the paper sheet ESP without being required to significantly “push” the opposing sides of the slit within the paper sheet ESP to accommodate the passage or penetration of the blades B. As another example, the angle of sharpness a (alpha) of the tip end of the blades can be substantially reduced so as to effect cleaner and better cutting (e.g., for reasons as discussed above). As another example, the angle of inclination 8 (theta) along a side of the blade B can also be made steeper (i.e., so as to extend more transversely to the plane of the paper sheet ESP) such as to, e.g., more easily cut into the paper sheet ESP.

According to some illustrative embodiments, as shown in FIG. 10A, a blade B can be configured that includes a substantially flat side (e.g., see left side of blade shown in FIG. 10A) and an angled side along the opposite side of the blade (e.g., see angle θ (theta) shown in FIG. 10A). Notably, this configuration can provide a narrower and sharper blade design.

According to some illustrative embodiments, the blade B can have a width that is substantially narrower than that of prior crush-cutting blades. For example, in some embodiments, the blades B can have a width in the direction of the arrows A1 in FIG. 10A of less than 50 mils (0.050 inches), and, in some embodiments, the blades B can have a width of less than 40 mils, and, in some embodiments, the blades B can have a width of less than 30 mils, and, in some embodiments, the blades B can have a width of less than 25 mils, and, in some embodiments, the blades B can have a width of less than 20 mils, and, in some embodiments, the blades B can have a width of less than 15 mils, and, in some embodiments, the blades B can have a width of less than 10 mils. In some embodiments, the blades B can have a width at a location BWm shown in FIG. 10A of less than 40 mils, and, in some embodiments, the blades B can have a width BWm of less than 30 mils, and, in some embodiments, the blades B can have a width BWm of less than 25 mils, and, in some embodiments, the blades B can have a width BWm of less than 20 mils, and, in some embodiments, the blades B can have a width BWm of less than 15 mils, and, in some embodiments, the blades B can have a width BWm of less than 10 mils, and, in some embodiments, the blades B can have a width BWm of less than 5 mils.

In some embodiments, the blades B can have an a (alpha) of less than 35 degrees, and, in some embodiments, less than 25 degrees, and, in some embodiments, less than 15 degrees, and, in some embodiments, less than 10 degrees, and, in some embodiments, less than 5 degrees. In some embodiments, the angle α (alpha) can be created by a blade having a bevel on both sides or by a blade having a bevel on one side similar to that shown in FIG. 10A. Notably, as discussed above, when a bevel is on one side, the angle α (alpha) can often be more readily reduced.

In some embodiments, the blades B can have an 8 (theta) of greater than 55 degrees, and, in some embodiments, greater than 65 degrees, and, in some embodiments, greater than 75 degrees, and, in some embodiments, greater than 80 degrees, and, in some embodiments, greater than 85 degrees.

With reference to FIG. 10B, FIG. 10B is another schematic diagram showing a side view similar to that shown in FIG. 10A, without the blade and with further details related to the intermediary material layer IM according to some embodiments. As described with respect to FIG. 10A, a paper sheet ESP has an upper surface Ets, and a bottom surface Ebs, and is located upon the intermediary material layer IM, As indicated in FIG. 10B, the intermediary material layer IM has a thickness IMt. As described herein within this document, in the preferred embodiments, the intermediary material layer IML is placed upon and supported by a rigid (e.g., metal and/or the like) member (not shown in FIG. 10B) which contacts and supports the entire intermediary member bottom surface IMbs.

As shown in FIG. 10B, after the blades B penetrate the intermediary material layer IM, the blades create openings or holes FDH into the intermediary material layer IM having a shape, size and configuration corresponding to the shape, size and configuration of the respective blades penetrating into the intermediary material layer IM. For example, as shown in FIG. 10B, the openings or holes FDH have a depth D, and a width BWm, which corresponds substantially to the shape, size and configuration of the respective blades. It should be appreciated that the views shown in FIGS. 10A-10C depict end views of slits, and that the corresponding widths of the slits (i.e., extending perpendicular to the views in FIGS. 10A-10C) would also correspond to the shape, size and configuration of the respective blades (which in some illustrative embodiments can be between about 0.25 to 0.5 inches or any other width in accordance with embodiments described in this document).

As described herein in this document, in the preferred embodiments the intermediary material layer IM preferably has a limited depth or thickness IMt. For example, in some illustrative embodiments the IMt is in the range from about 0.5 to 8 mils, or, in some other embodiments, in the range from about 0.75 to 7 mils, or, in some other embodiments, in the range from about 1.0 to 6 mils, or, in some other embodiments, in the range from about 1.5 to 5 mils, or, in some other embodiments, in the range from about 2.0 to 4.0 mils.

Although some most preferred embodiments are preferably within limited ranges as set forth above, in other embodiments, advantages of the present invention can be achieved with intermediary material layers IM have a depth of less than about 10 mils. Although some preferred embodiments are preferably within limited ranges as set forth above, in other embodiments, advantages of the present invention can also be achieved with intermediary material layers IM have a depth of less than about 20 mils. Although some preferred embodiments are preferably within limited ranges as set forth above, in other embodiments, advantages of the present invention can also be achieved with intermediary material layers IM have a depth of less than about 30 mils. Although some preferred embodiments are preferably within limited ranges as set forth above, in other embodiments, advantages of the present invention can also be achieved with intermediary material layers IM have a depth of less than about 40 mils. Although some preferred embodiments are preferably within limited ranges as set forth above, in other embodiments, advantages of the present invention can also be achieved with intermediary material layers IM have a depth of less than about 50 mils.

In contrast to the use of soft rubber anvils in the background art, the preferred embodiments of the present invention are capable of creating a male and female die pair by having the blades of the male die penetrate a novel intermediary material layer IM that is configured to create a corresponding female die having a shape, size and configuration corresponding to the shape, size and configuration of the respective blades penetrating into the intermediary material layer IM.

Towards that end, in the preferred embodiments the intermediary material layer IM is not formed of a highly springy material (e.g., material with a high spring constant) and is not formed of a substantial depth or thickness IMt in order to reduce the elasticity or springiness of the intermediary material layer IM and the amount of flexible distortion of the intermediary material layer IM imparted by the blades upon contact and penetration with the intermediary material layer IM. With reference to FIG. 10C, in the preferred embodiments, the material of the intermediary material layer IM and the depth D are preferably, thus, selected to avoid the intermediary material layer from significantly flexibly distorting and bending downwards in the direction of the arrow shown in FIG. 10C upon impingement by the respective blade. In the preferred embodiments, the intermediary material layer IM will bend downwardly a distance BD (shown in FIG. 10C) that is substantially less than the depth D; for example, in some embodiments, the distance BD is less than ¼ the depth D, and, in some more preferred embodiments, the distance BD is less than ⅕ the depth D, and, in some more preferred embodiments, the distance BD is less than ⅙ the depth D, and, in some more preferred embodiments, the distance BD is less than 1/7 the depth D, and, in some more preferred embodiments, the distance BD is less than ⅛ the depth D, and, in some more preferred embodiments, the distance BD is less than 1/9 the depth D, and, in some more preferred embodiments, the distance BD is less than 1/10 the depth D, and, in some more preferred embodiments, the distance BD is less than 1/20 the depth D, and, in some more preferred embodiments, the distance BD is less than 1/30 the depth D, and, in some more preferred embodiments, the distance BD is less than 1/40 the depth D, and, in some more preferred embodiments, the distance BD is less than 1/50 the depth D, and, in some more preferred embodiments, the distance BD is less than 1/75 the depth D, and, in some more preferred embodiments, the distance BD is less than 1/100 the depth D, and, in some more preferred embodiments, the distance BD is less than 1/200 the depth D.

With reference to FIG. 10D, in the preferred embodiments, the material of the intermediary material layer IM and the depth D are also preferably selected to avoid the intermediary material layer from significantly flexibly contracting upon impingement by the respective blade and then expanding upon removal of the respective blade. For example, in the preferred embodiments, the respective holes FDH formed within the intermediary material layer IM preferably substantially maintain a width BWm upon penetration of a single respective blade B. With reference to FIG. 10D, in the preferred embodiments, the material of the intermediary material layer IM and the depth D are, preferably, thus, also selected to avoid the intermediary material layer from significantly flexibly expanding to significantly close or reduce the size of the respective hole FDH. For example, in the preferred embodiments, the width RW of the respective hole FDH after removal of a respective blade that forms the respective hole FDH by penetrating the intermediate material layer IM upon the first impingement therewith is preferably substantially the same and corresponds to the width BWm of the respective blade. In the preferred embodiments, the width RW is preferably greater than ½ of the width BWm, and, in some more preferred embodiments, the width RW is preferably greater than ¾ of the width BWm, and, in some more preferred embodiments, the width RW is preferably greater than ⅘ of the width BWm, and, in some more preferred embodiments, the width RW is preferably greater than ⅚ of the width BWm, and, in some more preferred embodiments, the width RW is preferably greater than 6/7 of the width BWm, and, in some more preferred embodiments, the width RW is preferably greater than ⅞ of the width BWm, and, in some more preferred embodiments, the width RW is preferably greater than 8/9 of the width BWm, and, in some more preferred embodiments, the width RW is preferably greater than 10/11 of the width BWm, and, in some more preferred embodiments, the width RW is preferably greater than 15/16 of the width BWm, and, in some more preferred embodiments, the width RW is preferably greater than 20/21 of the width BWm, and, in some more preferred embodiments, the width RW is preferably greater than 25/26 of the width BWm, and, in some more preferred embodiments, the width RW is preferably greater than 50/51 of the width BWm, and, in some more preferred embodiments, the width RW is preferably greater than 75/76 of the width BWm, and, in some more preferred embodiments, the width RW is preferably greater than 100/101 of the width BWm, and, in some more preferred embodiments, the width RW is preferably greater than 200/201 of the width BWm, In some preferred embodiments, the widths of the holes FDH are within the foregoing ranges along the entire depth D.

In the preferred embodiments, after the initial penetration of the respective blades, a female die member is created having an array of female die receiving holes for receiving corresponding blades, such as, e.g., similar to that shown in the anvil 200 depicted in FIG. 1, having female die receiving holes (e.g., recesses or grooves 205). Upon the formation of such holes FDH, 205, in operation with repeated use of the die, the blades preferably continue to repeatedly enter within the receiving holes FDH, 205 in the formation of additional slits within the paper.

In the preferred embodiments, an anvil is, thus, created in which blades B form corresponding holes FDH, which holes are, in preferred embodiments, in accordance with embodiments thereof described herein consistently across a periphery of the anvil or the like. For example, in some preferred embodiments, locations in which the respective blades impinge against the intermediary material layer IM preferably form such holes FDH described herein-above at 80% or more of the locations in which the respective blades imping against the intermediary material (upon each single respective impingement in which a blade is brought into and out of contact with the layer IM) form such a hole FDH described herein-above, and, more preferably, 90% or more of the locations in which the respective blades imping against the intermediary material (upon each single respective impingement in which a blade is brought into and out of contact with the layer IM) form such a hole FDH described herein-above, and, more preferably, 95% or more of the locations in which the respective blades imping against the intermediary material (upon each single respective impingement in which a blade is brought into and out of contact with the layer IM) form such a hole FDH described herein-above, and, more preferably, 97.5% or more of the locations in which the respective blades imping against the intermediary material (upon each single respective impingement in which a blade is brought into and out of contact with the layer IM) form such a hole FDH described herein-above, and, more preferably, 99% or more of the locations in which the respective blades imping against the intermediary material (upon each single respective impingement in which a blade is brought into and out of contact with the layer IM) form such a hole FDH described herein-above, 99% or more of the locations in which the respective blades imping against the intermediary material (upon each single respective impingement in which a blade is brought into and out of contact with the layer IM) form such a hole FDH described herein-above, and, more preferably, 99.5% or more of the locations in which the respective blades imping against the intermediary material (upon each single respective impingement in which a blade is brought into and out of contact with the layer IM) form such a hole FDH described herein-above, and, more preferably, 99.75% or more of the locations in which the respective blades imping against the intermediary material (upon each single respective impingement in which a blade is brought into and out of contact with the layer IM) form such a hole FDH described herein-above, and, more preferably, 99.9% or more of the locations in which the respective blades imping against the intermediary material (upon each single respective impingement in which a blade is brought into and out of contact with the layer IM) form such a hole FDH described herein-above, and, more preferably, 100% of the locations in which the respective blades imping against the intermediary material (upon each single respective impingement in which a blade is brought into and out of contact with the layer IM) form such a hole FDH described herein-above.

In the preferred embodiments, the intermediary material layer plastically distorts upon the first initial impingement of the respective blade to create the corresponding female die hole FDH, whereby creating a female die. Preferably, during use of the female die after formation of the female die holes FDH upon the entire periphery, as the male and female die members repeatedly reciprocate or rotate toward and away from one another, the knife blades enter the formed holes but do not significantly impinge or further the intermediary material layer, such that the blades B enter and exit such created holes. In the preferred embodiments, such blades create corresponding female die holes FDH that can achieve clean and accurate slits in the formation of high quality expandable slit sheet paper.

In contrast, in the context of prior soft rubber, blades have tendency to repeated impact with rubber, due to expanding (e.g., spring and flexibility) of the rubber and/or the blades not aligning with previously formed holes—thus, leading to wear and degrading of the rubber.

Because the preferred embodiments involve the cutting of thin sheets of paper with small blades that repeatedly cut numerous slits into sheets of paper in the formation of expandable slit sheet paper, with small slits (e.g., plus-or-minus ½ inch) that are in closely spaced rows (e.g., plus-or-minus ⅛ inch), this repetition within small, tightly-packed, blades readily leads to wear and degradation absent employing teachings of the present invention.

With reference to FIG. 11, FIG. 11 shows an illustrative background art system for employing a crush cut type of structure. According to some illustrative embodiments, the system shown in FIG. 11 can be upgraded to an embodiment in accordance with the present invention by incorporating an intermediary material layer IM around an anvil portion.

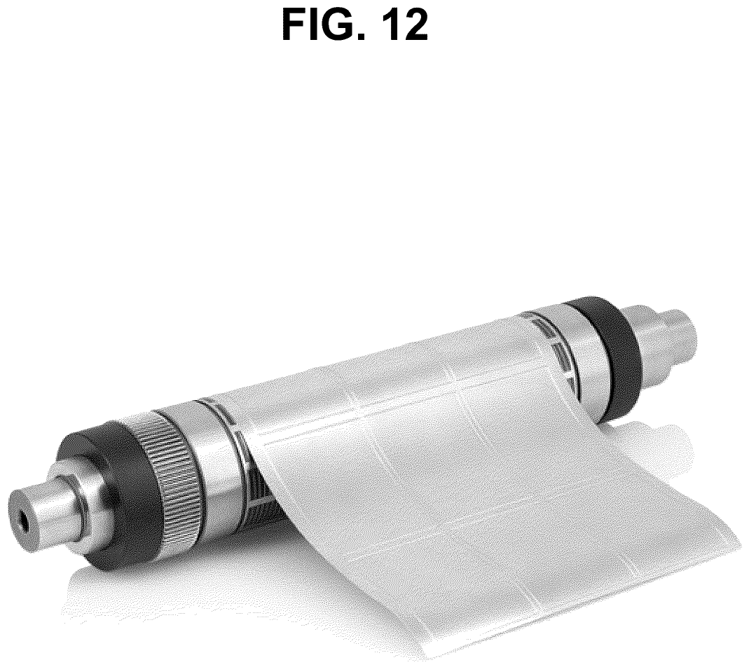

With reference to FIG. 12, FIG. 12 shows an illustrative background art die roller having a flexible die mounted thereto. Although the flexible die in FIG. 12 is not employed to receive blades that penetrate therein (e.g., not being employed in an anvil), in some embodiments an intermediary material layer IM can be provided that employs a material similar to that of the flexible die shown in FIG. 12.

### Additional Aspects of Some Illustrative Embodiments

1. According to some embodiments of the invention, a system for making an expandable slit sheet material by forming slits within a sheet of material is provided that includes an intermediary material layer that is provided which includes a laminated structure or material made of one or more layers fixed together to form a soft, flexible material.

2. According to some embodiments of the invention, a system for making an expandable slit sheet material by forming slits within a sheet of material is provided that includes a releasable laminate that includes one or more layers fixed together to form a soft, flexible material that is releasably bonded to a substrate.

3. According to some embodiments of the invention, the above aspects 1 or 2 can include a releasable laminate having a thickness in the range from about 0.5 to 8 mils, or, in some other embodiments, preferably in the range from about 0.75 to 7 mils, or, in some other embodiments, preferably in the range from about 1.0 to 6 mils, or, in some other embodiments, preferably in the range from about 1.5 to 5 mils, or, in some other embodiments, preferably in the range from about 2.0 to 4.0 mils.

4. According to some illustrative embodiments, the above aspects 1, 2 or 3, include a laminate that is a film of a non-fabric material.

5. According to some illustrative embodiments, the above aspect 4 includes a film comprising a thin flexible strip of plastic or other material.

6. According to some illustrative embodiments, the laminate in any of the above aspects can include a pressure sensitive lamination film. In some embodiments, the pressure sensitive lamination film is a material that does not require heat and is most commonly utilized with an unheated laminating system.

7. According to some illustrative embodiments, the lamination film in any of the above aspects can be applied by an adhesive, glue or other connection means. In some embodiments, an adhesive is employed that adheres upon application of pressure against a substrate (e.g., a material of an anvil), rather than via heating such as, e.g., a hot glue.

8. According to some illustrative embodiments, an of the above aspects can include a releasable self-adhesive film laminate designed for releasable attachment to a substrate such as, e.g., a metal anvil.

9. According to some illustrative embodiments, a releasable self-adhesive film laminate for an anvil member is provided.

10. According to some illustrative embodiments, a bladed roller is provided in combination with an anvil roller having a film laminate thereon, and, preferably, wherein the film laminate is a releasable self-adhesive film laminate adhered to the anvil roller.

11. According to some illustrative embodiments, a system and method for producing slits in a sheet of paper or other material is provided that passes the sheet of paper or other material between a bladed roller and an anvil roller having an intermediary material film layer thereon, wherein the blades of the bladed roller pass through the sheet of paper or other material and penetrate into the intermediary material film layer.

Broad Scope of the Invention

While illustrative embodiments of the invention have been described herein, the present invention is not limited to the various preferred embodiments described herein, but includes any-and-all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.”

The use of individual numerical values is stated as approximations as though the values were preceded by the word “about”, “substantially”, or “approximately.” Similarly, the numerical values in the various ranges specified in this application, unless expressly indicated otherwise, are stated as approximations as though the minimum and maximum values within the stated ranges were both preceded by the word “about”, “substantially”, or “approximately.” In this manner, variations above and below the stated ranges can be used to achieve substantially the same results as values within the ranges. As used herein, the terms “about”, “substantially”, and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about”, “substantially”, or “approximately” will serve to broaden a particular numerical value or range. Thus, as a general matter, “about”, “substantially”, or “approximately” broaden the numerical value. Also, the disclosure of ranges is intended as a continuous range including every value between the minimum and maximum values plus the broadening of the range afforded by the use of the term “about”, “substantially”, or “approximately”. Thus, recitation of ranges of values herein are merely intended to serve as a shorthand method of referring individually to each separate value falling within the range, unless otherwise indicated herein, and each separate value is incorporated into the specification as if it were individually recited herein. To the extent that determining a given amount of variation of some the factors such as the criticality of the slit patterns, paper width differential pre- and post-expansion, paper weights and type, as well as other considerations known to those of skill in the art to which the disclosed subject matter is most closely related or the art relevant to the range or element at issue will have on the performance of the claimed subject matter, is not considered to be within the ability of one of ordinary skill in the art, or is not explicitly stated in the claims, then the terms “about”, “substantially”, and “approximately” should be understood to mean the numerical value, plus or minus 15%.

It is to be understood that any ranges, ratios and ranges of ratios that can be formed by, or derived from, any of the data disclosed herein represent further embodiments of the present disclosure and are included as part of the disclosure as though they were explicitly set forth. This includes ranges that can be formed that do or do not include a finite upper and/or lower boundary. Accordingly, a person of ordinary skill in the art most closely related to a particular range, ratio or range of ratios will appreciate that such values are unambiguously derivable from the data presented herein.

1-23. (canceled)

24. A method of upgrading a system for making expandable slit sheet material,comprising:
a) providing a system for making expandable slit sheet material by pressing a die member having an array of blades against an anvil member with a sheet of material between said die member and said anvil so that said sheet of material is cut by said blades to form an array of slits;
b) providing an intermediary material layer upon said anvil such that during pressing of the die member having said array of blades against said anvil member with a sheet of material between said die member and said anvil so that said sheet of material is cut by said blades to form an array of slits, said blades also pass through said sheet of material and penetrate said intermediary material layer.

25. The method of claim 24, wherein said intermediary material layer is a plastic or elastomeric layer.

26. The method of claim 24, wherein said intermediate material layer is attached to said anvil member with an adhesive.

27. The method of claim 24, wherein said intermediate material layer is between about 0.25 mil and 10 mil thick.

28. The method of claim 24, wherein said intermediate material layer is between about 0.75 mil and 8 mil thick.

29. The method of claim 24, wherein said intermediate material layer is between about 1.5 mil and 7 mil thick.

30. The method of claim 24, wherein said intermediate material layer is between about 2.0 mil and 6 mil thick.

31. The method of claim 24, wherein said intermediate material layer is between about 2.5 mil and 5 mil thick.

32. The method of claim 24, wherein said intermediate material layer is form from one or more of:
a) a fibrous material;
b) a paper material;
c) a natural material;
d) a synthetic material;
e) a polymeric material;
f) an elastomeric material;
g) a plastic material;
h) a metal.

33. The method of claim 24, wherein said intermediate material layer is formed of a material of sufficient softness that said blades penetrate into said intermediate material layer.

34. The method of claim 24, wherein said blades have a maximum width (BWm) at a location that penetrates a sheet of material of less than less than 40 mils.

35. The method of claim 24, wherein said blades have an angle α (alpha) of less than 35 degrees.

36. The method of claim 24, wherein said blades have a bevel on both sides of the blade.

37. The method of claim 24, wherein said blades have a bevel on only one side of the blade.

38. The method of claim 24, wherein said blades have a bevel angle θ (theta) of greater than 55 degrees.

39. A method, comprising:
forming a male and female die pair for making expandable slit sheet paper by:
providing a first male die member having an array of blades for forming an array of slits within a paper sheet to form an expandable slit sheet paper;
pressing said first male die member against a second member, said second member preferably having a rigid member with an intermediary material layer along a peripheral side of said rigid member facing said first die member, such that said blades penetrate said intermediary material layer and create an array of corresponding female die holes, whereby the second member is formed to a female die member, and withdrawing said blades from said corresponding female die holes.

40. The method of claim 39, further including:
wherein said step of pressing is performed either a) without a sheet of paper between said first male die member and said second member such as to be prior to forming of any expandable slit sheet paper with the male and female die pair of said first male die member and said second female die member; or b) with a sheet of paper between said first male die member and said second member such as to concurrently form an initial expandable slit sheet paper with said sheet of paper concurrently with formation of the male and female die pair of said first male die member and said second female die member.

41. The method of claim 39, wherein the expandable slit sheet paper includes an array of slits with a width of between about 0.2 to 0.45 inches.

42. The method of claim 39, wherein the expandable slit sheet paper includes an array of slits with a spacing between rows of slits of about ⅛ inch or less.

43. The method of claim 39, wherein the expandable slit sheet paper includes an array of slits that expand into generally hexagonal cells upon expansion.

44. The method of claims 39, further including that said holes of said female die holes are formed such as to correspond substantially to the shape and size of the respective blades.

45. The method of claim 39, further including that said intermediary material layer plasticly deforms upon penetration of said blades such that said holes of said female die holes are formed such as to correspond substantially to the shape and size of the respective blades.

46. The method of claim 39, wherein the respective female die holes formed within the intermediary material layer IM have a width substantially corresponding to a width (BWm) of a corresponding blade upon penetration and withdrawal of the single respective blade B.
